(19) United States
(12) Patent Application Publication
(10) Pub. No.: US 2026/0075628 A1
(43) Pub. Date: Mar. 12, 2026

(54) SIDELINK COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN)

(73) Assignee: GUANGDONG OPPO MOBILE TELECOMMUNICATIONS CORP., LTD., Dongguan (CN)

(21) Appl. No.: 19/387,277

(22) Filed: Nov. 12, 2025

Related U.S. Application Data
(63) Continuation of application No. PCT/CN2023/108116, filed on Jul. 19, 2023.

(51) Int. Cl. H04W 72/25; H04L 47/24

(52) U.S. Cl. CPC H04W 72/25; H04L 47/24

(57) ABSTRACT

A method for sidelink communication includes: a first terminal device sends first information to a second terminal device through a first carrier; and the first terminal device receives or sends second information through a second carrier. The first carrier is different from the second carrier, and the second information is associated with the first information.

### CROSS-REFERENCE TO RELATED APPLICATION

This application is a continuation of International Application No. PCT/CN2023/108116 filed on Jul. 19, 2023, the disclosure of which is hereby incorporated by reference in its entirety.

### BACKGROUND

At present, when transmission of first information and second information associated with the first information is performed between the first terminal device and the second terminal device, the transmission of the first information and the second information needs to be performed through a same carrier, resulting in poor flexibility in the transmission mode of the first information and the second information.

### SUMMARY

The present disclosure relates to the technical field of communications, and provides a method for sidelink communication, a first terminal device, and a second terminal device. Various aspects of the present disclosure are described as follows.

In a first aspect, there is provided a method for sidelink communication, including: sending, by a first terminal device, first information to a second terminal device through a first carrier; and receiving or sending, by the first terminal device, second information through a second carrier. The first carrier is different from the second carrier, and the second information is associated with the first information.

In a second aspect, there is provided a first terminal device. The first terminal device includes a transceiver, a memory and a processor. The memory is configured to configured to store computer-executable instructions. The processor is configured to invoke and execute the computer-executable instructions in the memory to perform operations of: sending, via the transceiver, first information to a second terminal device through a first carrier; and receiving or sending, via the transceiver, second information through a second carrier. The first carrier is different from the second carrier, and the second information is associated with the first information.

In a third aspect, there is provided a second terminal device. The second terminal device includes a transceiver, a memory and a processor. The memory is configured to configured to store computer-executable instructions. The processor is configured to invoke and execute the computer-executable instructions in the memory to perform operations of: receiving, via the transceiver through a first carrier, first information sent by a first terminal device; and receiving or sending, via the transceiver, second information through a second carrier. The first carrier is different from the second carrier, and the second information is associated with the first information.

### BRIEF DESCRIPTION OF THE DRAWINGS

FIG. 1 is an exemplary diagram showing a system architecture of a wireless communication system to which embodiments of the present disclosure is applicable.

FIG. 2 is an exemplary diagram illustrating a scenario for sidelink communication within network coverage.

FIG. 3 is an exemplary diagram illustrating a scenario for sidelink communication within partial network coverage.

FIG. 4 is an exemplary diagram illustrating a scenario for sidelink communication outside network coverage.

FIG. 5 is an exemplary diagram illustrating a scenario for sidelink communication based on a central control node.

FIG. 6 is an exemplary diagram illustrating sidelink communication based on broadcast.

FIG. 7 is an exemplary diagram illustrating sidelink communication based on unicast.

FIG. 8 is an exemplary diagram illustrating sidelink communication based on multicast.

FIG. 9 is a schematic flowchart of a method for sidelink communication according to an embodiment of the present disclosure.

FIG. 10 is a schematic flowchart of a method for carrier configuration according to an embodiment of the present disclosure.

FIG. 11 is a schematic diagram of a terminal device according to an embodiment of the present disclosure.

FIG. 12 is a schematic diagram of a terminal device according to another embodiment of the present disclosure.

FIG. 13 is a schematic structural diagram of a communication device according to an embodiment of the present disclosure.

### DETAILED DESCRIPTION

Hereinafter, technical solutions in the present disclosure will be described with reference to the accompanying drawings.

### Communication System Architecture

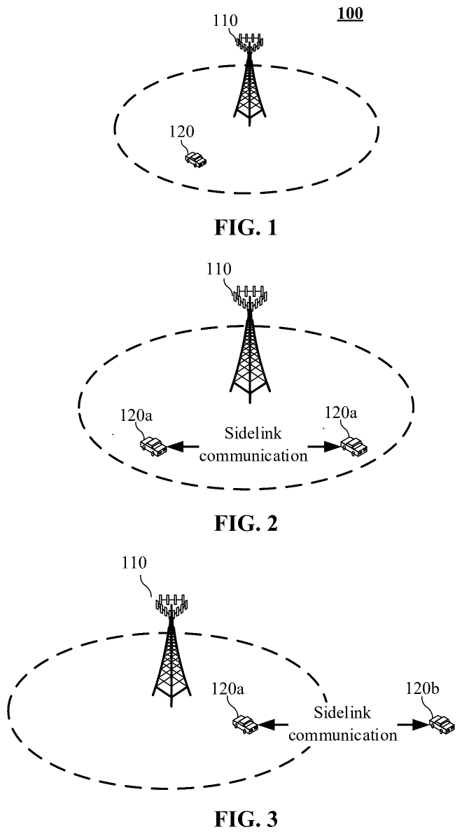

FIG. 1 is an exemplary diagram showing a system architecture of a wireless communication system 100 to which embodiments of the present disclosure is applicable. The wireless communication system 100 may include a network device 110 and a terminal device 120. The network device 110 may be a device in communication with the terminal device 120. The network device 110 may provide communication coverage for a particular geographic area and may communicate with the terminal device 120 located within the coverage area.

FIG. 1 exemplarily shows one network device and one terminal device. optionally, the wireless communication system 100 may include one or more network devices 110 and/or one or more terminal devices 120. For one network device 110, the one or more terminal devices 120 may all be located within a network coverage range of the network device 110, or may all be located outside the network coverage range of the network device 110; or, a part of the terminal devices may be located within the coverage range of the network device 110, and the other part of the terminal devices may be located outside the network coverage range of the network device 110. No limitations are imposed in this regard in the embodiments of the present disclosure.

Optionally, the wireless communication system 100 may further include other network entities such as a network controller and a mobility management entity. No limitations are imposed in this regard in the embodiments of the present disclosure.

It should be understood that the technical solutions of the embodiments of the present disclosure can be applied to various communication systems, such as a Fifth Generation (5G) system or a New Radio (NR) system, a Long Term Evolution (LTE) system, an LTE Frequency Division Duplex (FDD) system, an LTE Time Division Duplex (TDD), and the like. The technical solutions provided in the present disclosure can also be applied to future communication systems, such as a sixth generation mobile communication system, a satellite communication system, and the like.

The terminal device in the embodiment of the present disclosure may also be referred to as User Equipment (UE), an access terminal, a subscriber unit, a subscriber station, a Mobile Station (MS), a Mobile Terminal (MT), a remote station, a remote terminal device, a mobile device, a user terminal, a wireless communication device, a user agent, or a user device. The terminal device in the embodiment of the present disclosure may be a device that provides voice and/or data connectivity to a user, and may be used to connect people, objects, and machines, for example, a handheld device or vehicle-mounted device that has a wireless connection function, or the like. The terminal device in the embodiment of the present disclosure may be a mobile phone, a tablet computer (or Pad), a laptop, a handheld computer, a Mobile Internet Device (MID), a wearable device, a vehicle, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. For example, a terminal device may act as a scheduling entity that provides sidelink signals between terminal devices in Vehicle-to-Everything (V2X) or Device-to-Device (D2D) communication, etc. For example, a cellular phone and an automobile communicate with each other using sidelink signals. A cellular phone and a smart home device communicate with each other without communication signals relayed through a base station. Alternatively, the terminal device may be used to act as a base station.

The network device in the embodiments of the present disclosure may be a device for communicating with a terminal device, and the network device may also be referred to as an access network device or a radio access network device, for example, the network device may be a base station. The network device in the embodiments of the present disclosure may refer to a radio access network (RAN) node (or device) that connects the terminal device to a wireless network. The base station may broadly cover, or be substituted by, various names such as a Node B (NodeB), an evolved NodeB (eNB), a next generation NodeB (gNB), a relay station, an access point, a transmitting and receiving point (TRP), a transmitting point (TP), a master eNB (MeNB), a secondary eNB (SeNB), a Multi-Standard Radio (MSR) node, a home base station, a network controller, an access node, a wireless node, an Access Point (AP), a transmission node, a transceiver node, a Base Band Unit (BBU), a Remote Radio Unit (RRU), an Active Antenna Unit (AAU), a Remote Radio Head (RRH), a Central Unit (CU), a Distributed Unit (DU), and a positioning node. The base station may be a macro base station, a micro base station, a relay node, a donor node, or the like, or a combination thereof. The base station may also refer to a communication module, modem, or chip arranged within the aforementioned apparatus or device. The base station may be a mobile switching center, a device that assumes the function of a base station in Device-to-Device (D2D), V2X, or Machine-to-Machine (M2M) communication, a network-side device in a 6G network, a device that assumes the function of a base station in a future communication system, or the like. The base stations may support networks of the same or different access technologies. The embodiments of the present disclosure do not limit the specific technology and the specific form of devices adopted by the network device.

The base station may be fixed or mobile. For example, a helicopter or drone may be configured to act as a mobile base station, and one or more cells may move according to the location of the mobile base station. In other examples, a helicopter or drone may be configured as a device to communicate with another base station.

In some deployments, the network device in the embodiments of the present disclosure may refer to a CU or a DU, or the network device includes a CU and a DU. The gNB may also include an AAU.

The network device and the terminal device can be deployed on land, including indoor or outdoor environments, handheld or vehicle-mounted; they can also be deployed on the water; and they can also be deployed on aircrafts, balloons and satellites in the air. The scenario in which the network device and the terminal device are located is not limited in the embodiments of the present disclosure.

### Sidelink Communication Under Different Network Coverages

The sidelink communication refers to a sidelink-based communication technology. The sidelink communication may be, for example, Device-to-Device (D2D) or Vehicle-to-Everything (V2X) communication. In a conventional cellular system, communication data is received or sent between a terminal device and a network device, while the sidelink communication supports direct communication data transmission between terminal devices. Compared with traditional cellular communication, the direct transmission of communication data between terminal devices can have higher spectral efficiency and lower transmission delay. For example, the Internet of Vehicles (IoV) system uses the sidelink communication technology.

According to the network coverage in which the terminal device is located, the sidelink communication may be divided into sidelink communication within the network coverage, sidelink communication within partial network coverage, and sidelink communication outside the network coverage.

FIG. 2 is an exemplary diagram illustrating a scenario for sidelink communication within network coverage. In the scenario shown in FIG. 2, both terminal devices 120a are within the coverage range of a network device 110. Therefore, both terminal devices 120a may receive configuration signaling of the network device 110 (the configuration signaling in the present disclosure may also be replaced with configuration information), and determine a sidelink configuration according to the configuration signaling of the network device 110. After sidelink configuration is performed on both of the terminal devices 120a, the sidelink communication can be performed on the sidelink.

FIG. 3 is an exemplary diagram illustrating a scenario for sidelink communication within partial network coverage. In the scenario shown in FIG. 3, the terminal device 120a performs sidelink communication with the terminal device 120b. Since the terminal device 120a is located within the coverage range of the network device 110, the terminal device 120a can receive the configuration signaling of the network device 110 and determine the sidelink configuration according to the configuration signaling of the network device 110. The terminal device 120b is located outside the network coverage range and cannot receive the configuration signaling of the network device 110. In this case, the terminal device 120b may determine the sidelink configuration according to the pre-configuration information and/or information carried in a Physical Sidelink Broadcast Channel (PSBCH) transmitted by the terminal device 120a located within the network coverage. After sidelink configuration is performed on both the terminal device 120a and the terminal device 120b, sidelink communication can be performed on the sidelink.

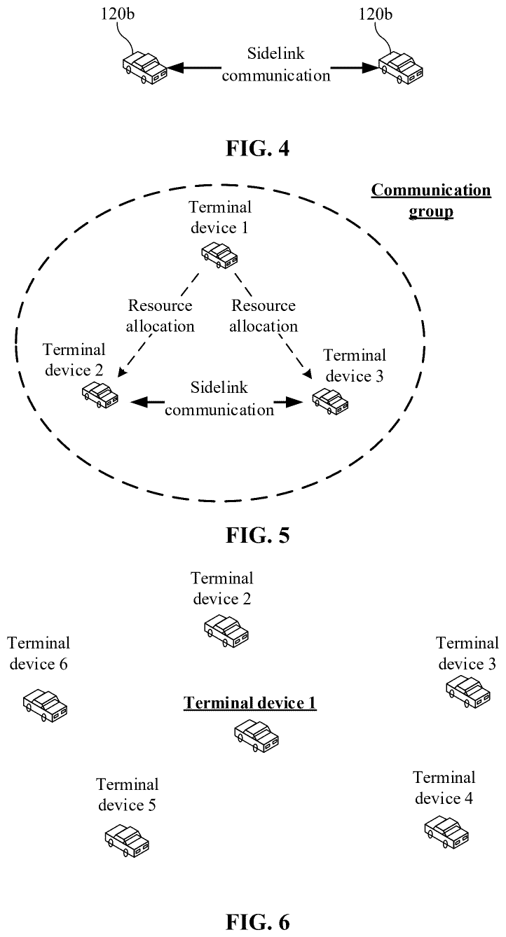

FIG. 4 is an exemplary diagram illustrating a scenario for sidelink communication outside network coverage. In the scenario shown in FIG. 4, both terminal devices 120b are located outside network coverage. In this case, both of the terminal devices 120b may determine the sidelink configuration according to the pre-configuration information. After sideelink configuration is performed on both of the terminal devices 120b, the sidelink communication can be performed on the sidelink.

### Sidelink Communication Based on Central Control Node

FIG. 5 is an exemplary diagram illustrating a scenario for sidelink communication based on a central control node. In this sidelink communication scenario, a plurality of terminal devices may form a communication group, and the communication group has a central control node. The central control node may be a terminal device in a communication group (such as terminal device 1 in FIG. 5), and the terminal device may also be referred to as a Cluster Header (CH) terminal device. The central control node may be responsible for performing one or more of the following functions: establishing a communication group, joining (or keeping) a group member into (or away from) the communication group, coordinating resources within the communication group, allocating sidelink transmission resources for other terminal devices, receiving fourth sidelink data of other terminal devices, and coordinating resources with other communication groups.

### Modes of Sidelink Communication

Certain standards or protocols, such as the 3rd Generation Partnership Project (3GPP), define two modes of sidelink communication: a first mode and a second mode.

In the first mode, resources of the terminal device (the resources mentioned in the present disclosure may also be referred to as transmission resources, such as time-frequency resources) are allocated by the network device. The terminal device may send data on the sidelink according to resources allocated by the network device. The network device may allocate resources for a single transmission to the terminal device, or may allocate resources for semi-static transmission to the terminal device. The first mode can be applied to a scenario within network device coverage, such as the scenario shown in FIG. 2. In the scenario shown in FIG. 2, since the terminal device 120a is located within the network coverage range of the network device 110, the network device 110 may allocate resources to be used by the terminal device 120a in the sidelink transmission process.

In the second mode, the terminal device may autonomously select one or more resources in a Resource Pool (RP). Then, the terminal device may perform sidelink transmission according to the selected resource(s). For example, in the scenario shown in FIG. 4, the terminal device 120b is located outside the cell coverage range. Therefore, the terminal device 120b may autonomously select resource(s) in the pre-configured resource pool for sidelink transmission. Alternatively, in the scenario shown in FIG. 2, the terminal device 120a may autonomously select one or more resources from the resource pool configured by the network device 110 to perform sidelink transmission.

### Data Transmission Manners of Sidelink Communication

Certain sidelink communication systems (such as Long Term Evolution Vehicle to Everything (LTE-V2X) system) support broadcast-based data transmission manner (hereinafter referred to as broadcast transmission). For the broadcast transmission, a receiving-end terminal may be any terminal device around a sending-end terminal. Taking FIG. 6 as an example, the terminal device 1 is a sending-end terminal, and the receiving-end terminal corresponding to the sending-end terminal is any one of terminal devices around the terminal device 1, which may be, for example, a terminal device 2 to a terminal device 6 in FIG. 6.

In addition to the broadcast transmission, some communication systems support a unicast-based data transmission manner (hereinafter referred to as unicast transmission) and/or a multicast-based data transmission manner (hereinafter referred to as multicast transmission). For example, the New Radio Vehicle to Everything (NR-V2X) hopes to support autonomous driving. The autonomous driving puts forward higher requirements for data interaction between vehicles. For example, data interaction between vehicles requires higher throughput, lower latency, higher reliability, greater coverage, more flexible resource allocation mode, etc. Therefore, in order to improve the data interaction performance between vehicles, the NR-V2X introduces unicast transmission and multicast transmission.

For the unicast transmission, the receiving-end terminal is generally only one terminal device. Taking FIG. 7 as an example, the unicast transmission is performed between the terminal device 1 and the terminal device 2. The terminal device 1 may be a sending-end terminal, and the terminal device 2 may be a receiving-end terminal, or the terminal device 1 may be the receiving-end terminal, and the terminal device 2 may be the sending-end terminal.

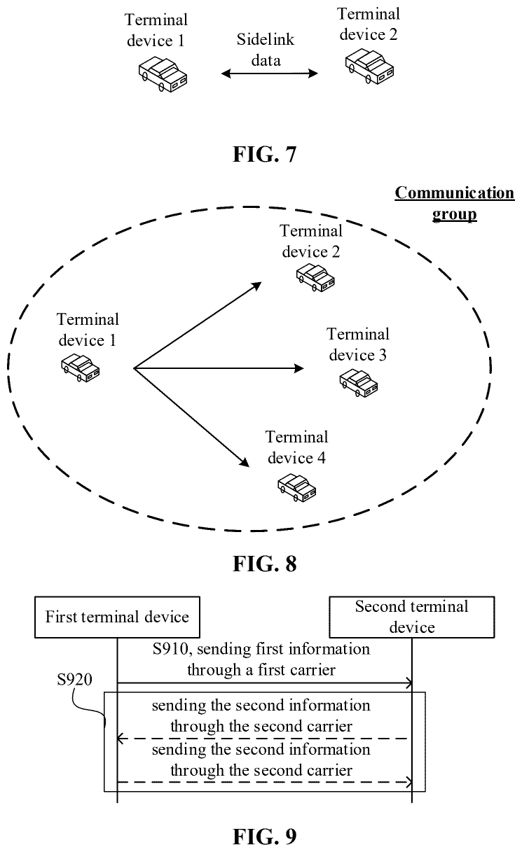

For the multicast transmission, the receiving-end terminal may be a terminal device within a communication group, or the receiving-end terminal may be a terminal device within a certain transmission distance. Taking FIG. 8 as an example, the terminal device 1, the terminal device 2, the terminal device 3, and the terminal device 4 constitute one communication group. If the terminal device 1 sends data, the other terminal devices (the terminal device 2 to the terminal device 4) in the group may all be receiving-end terminals.

### Carrier Aggregation Technology

In order to meet the requirements of single-user peak rate and system capacity improvement, one of the most direct ways is to increase the system transmission bandwidth. Therefore, a technology for increasing transmission bandwidth, that is, the Carrier Aggregation (CA) technology, is introduced into communication systems. Using the CA technology, multiple (e.g., 2 to 5) component carriers (CCs) can be aggregated together to increase the transmission bandwidth and effectively improve uplink and downlink transmission rates.

In some implementations, the CCs participating in the aggregation may be carriers that are adjacent to each other in a frequency band, or may also be carriers that are not adjacent to each other in a frequency band.

In other implementations, CA techniques may be classified according to the range of aggregated carriers, and the types of CA may be divided into intra-band CA and inter-band CA. As the name implies, for the intra-band CA, CCs participating in carrier aggregation belong to a same frequency band. For the inter-band CA, CCs participating in carrier aggregation belong to a plurality of different frequency bands.

In order to facilitate understanding, the following introduces the CA technology by taking, as examples, a scenario in which the network device communicates with the terminal device and a sidelink communication scenario in which communication is performed between terminal devices.

In the communication scenario between the network device and the terminal device, the CA is a bandwidth expansion technology supported since the LTE-Advanced standard. It can aggregate multiple CCs so that one terminal device can perform reception and sending at the same time. In this scenario, the intra-band CA may be used in a case where a cell carrier bandwidth is larger than an individual carrier bandwidth capability of the terminal device, and in which case, the terminal device may perform operations in a “wide carrier” in a CA manner.

For example, the network device supports a carrier of 300 MHz, and the terminal device only supports a carrier of 100 MHz at the maximum. In this case, in order to improve the transmission rate between the terminal device and the network device, the terminal device may communicate with the network device using a broadband greater than 100 MHz in a CA manner.

In some scenarios, when CA-based communication is performed between the terminal device and the network device, a primary cell (PCell) and a secondary cell (SCell) may be configured at the same time, where the secondary cell may include a primary secondary cell (PSCell). At present, in known communication protocols (for example, NR R15) , a beam failure recovery mechanism is designed for PCell and PSCell, and its main functional modules (or main steps) can be divided into: Beam Failure Detection (BFD); New Beam Identification (NBI); Beam Failure Recovery ReQest (BFRQ) and a network-side response.

That is to say, in the BFD step, the terminal device may measure the Physical Downlink Control Channel (PDCCH) to determine the link quality corresponding to the downlink transmission beam. If the corresponding link quality is poor, it is considered that the downlink beam has a beam failure. Then, the process proceeds to the NBI step, the terminal device can measure a group of candidate beams, and select a beam satisfying a certain threshold from the candidate beams as a new beam. Then, the terminal device notifies, through the BFRQ process, the network device that a beam failure has occurred, and reports the selected new beam. Accordingly, in the network-side response step, after receiving the BFRQ information sent by the terminal device, the network device may know that the terminal device has a beam failure, and selects the new beam for PDCCH transmission, and then the network device sends the PDCCH to the terminal device on the new beam, and accordingly, after the terminal device receives the PDCCH on the new beam, it may be considered that the network-side response information has been correctly received. At this point, the beam failure recovery process is completed successfully.

In the sidelink communication scenario, when a terminal device communicates with other terminal devices in a broadcast or multicast manner, the terminal device may select a set of carriers corresponding to a service to which data to be transmitted belongs based on a mapping relationship between pre-stored service types and sets of carriers, and perform carrier aggregation based on the selected set of carriers to communicate with other terminal devices.

In some implementations, the terminal device may determine CCs for carrier aggregation from the selected set of carriers based on a Channel Busy Ratio (CBR). For example, the terminal device may measure the CBR in the resource pool and compare it with a CBR threshold value corresponding to the priority of data to be transmitted, and if the measured CBR value is lower than the CBR threshold value, the terminal device may consider that the carrier can be used for carrier aggregation. Conversely, if the measured CBR value is higher than or equal to the CBR threshold value, the terminal device may consider that the carrier cannot be used for carrier aggregation.

### Cross-Carrier Scheduling

Currently, cross-carrier scheduling may be supported in a scenario where communication is performed between a network device and a terminal device. That is to say, for the cross-carrier scheduling with a Carrier Indication Field (CIF), the PDCCH of one serving cell is allowed to schedule resources of another different serving cell, but the following restrictions exist.
Restriction 1: a PCell cannot use cross-carrier scheduling, that is, PCell always schedules through its own PDCCH.
Restriction 2: If an SCell is configured with a PDCCH, a Physical Downlink Shared Channel (PDSCH) and a Physical Uplink Shared Channel (PUSCH) of this cell are always scheduled through the PDCCH of this SCell.
Restriction 3: If one SCell is not configured with a PDCCH, the PDSCH and PUSCH of this SCell are always scheduled by the PDCCH of another serving cell.

Generally, one scheduling PDCCH and the scheduled PDSCH/PUSCH may use a same sub-carrier spaces (SCS) or different SCSs. Before R16, cross-carrier scheduling supports the same SCS for the scheduling PDCCH and the scheduled PDSCH/PUSCH; but since R16, there is no such restriction, and the configuration of the same SCS or different SCSs may be supported.

At present, when transmission of first information and second information associated with the first information is performed between the first terminal device and the second terminal device, the transmission of the first information and the second information needs to be performed through a same carrier, resulting in poor flexibility in the transmission mode of the first information and the second information.

Taking the first information being sidelink data and the second information being feedback information for the sidelink data as an example, if a first terminal device sends sidelink data to a second terminal device, the second terminal device also needs to send feedback information to the first terminal device through the first carrier accordingly, resulting in poor flexibility in the transmission of the sidelink data and the feedback information.

In other scenarios, if the first terminal device sends a plurality of pieces of sidelink data through a plurality of carriers, respectively, receiving ends of the plurality of sidelink data need to send feedback information for respective pieces of sidelink data to the first terminal device through carriers for transmission of the sidelink data, respectively, resulting in a large power consumption of the first terminal device.

For example, the first terminal device sends sidelink data 1 to the second terminal device through a carrier 1, and sends sidelink data 2 to the third terminal device through a carrier 2. Accordingly, the second terminal device needs to send the feedback information for the sidelink data 1 to the first device through the carrier 1, and the third terminal device needs to send feedback information for the sidelink data 2 to the first device through the carrier 2, so that the first terminal device needs to receive the feedback information on the carrier 1 and the carrier 2, respectively, resulting in a large power consumption of the first terminal device.

Taking the second information being sidelink data and the first information being sidelink control information for scheduling the sidelink data as an example, if the first terminal device sends the sidelink control information to the second terminal device through the first carrier, the second terminal device also needs to send data information to the first terminal device through the first carrier accordingly, resulting in poor flexibility in the transmission of the sidelink data and the sidelink control information.

In other scenarios, if the first terminal device sends a plurality of pieces of sidelink control information through a plurality of carriers, receiving ends (including the second terminal device) of the sidelink control information need to send sidelink data to the first terminal device through carriers for transmission of the plurality pieces of sidelink control information, respectively, resulting in a large power consumption of the first terminal device.

For example, the first terminal device sends sidelink control information 1 to the second terminal device through a carrier 1, and sends sidelink control information 2 to the third terminal device through a carrier 2. Accordingly, the second terminal device needs to send sidelink data 1 scheduled by the sidelink control information 1 to the first device through the carrier 1, and the third terminal device needs to send sidelink data 2 scheduled by the sidelink control information 2 to the first device through the carrier 2, so that the first terminal device needs to receive the sidelink data 1 and the sidelink data 2 on the carrier 1 and the carrier 2, respectively, resulting in a large power consumption of the first terminal device.

Therefore, in view of the problem above, an embodiment of the present disclosure provides a method for sidellink communication. According to the method, transmission of the first information and the second information can be performed through different carriers (for example, the first carrier and the second carrier), which is helpful to improve the flexibility of transmission of the first information and the second information. In order to facilitate understanding, the method for sidelink communication according to the embodiment of the present disclosure will be described below with reference to FIG. 9. The method shown in FIG. 9 includes operations S910 to S920.

In operation S910, a first terminal device sends first information to a second terminal device through a first carrier.

In operation S920, the first terminal device receives or sends second information through a second carrier, where the first carrier is different from the second carrier.

In some implementations, the second information is associated with the first information. For example, the first information may include sidelink data, and the second information may include feedback information for the sidelink data, where the feedback information for the sidelink data may be used to indicate whether the second terminal device successfully receives the sidelink data. For another example, the first information may include sidelink control information, and the second information may include sidelink data scheduled by the sidelink control information, where the sidelink control information may be used, for example, to schedule sidelink resources for the sidelink data. Description will be made below based on a first embodiment and a second embodiment.

In some implementations, if the first terminal device receives the second information through the second carrier, the second information may be sent by the second terminal device. In other implementations, if the first terminal device sends the second information through the second carrier, the second information may be sent by the first terminal device to the second terminal device. In order to facilitate understanding, the description will be made based on a first embodiment to a third embodiment. In the first embodiment, what mainly described is a scheme where the second terminal device sends the second information to the first terminal device. In the second and third embodiments, what mainly described is a scheme where the first terminal device sends the second information to the second terminal device.

In the first embodiment, it is assumed that the first information includes sidelink data, and the second information includes feedback information for the sidelink data, or in other words, the first information is carried on a first Physical Sidelink Shared Channel (PSSCH), and the second information is carried on a first Physical Sidelink Feedback Channel (PSFCH) associated with the first PSSCH.

It should be noted that the sidelink data in the embodiment of the present disclosure may be initial transmission data or retransmission data. No limitations are imposed in this regard in the embodiments of the present disclosure.

As described above, the transmission of the first information and the second information may be performed through different carriers, thus how to determine the second carrier used for transmission of the second information is an urgent problem to be solved. Therefore, in view of this problem, it is proposed in the embodiment of the present disclosure that the second carrier may be determined based on some information (hereinafter, also referred to as “third information”) shared by the first terminal device and the second terminal device.

That is to say, the second carrier may be determined based on third information, where the third information includes one or more of: information of a target service type, information of a target service, information of a target application type, information of a target application, Layer 2 information, a transmission configuration, information of a target Quality of Service (QoS) flow, and a data transmission type.

Taking the third information including information of a target service type as an example, the target service type may be, for example, a service type of a service to which the sidelink data belongs. Herein, the target service type may include, for example, a rate-prioritized service type, a reliability-prioritized service type, and the like, and the embodiment of the present disclosure is not limited thereto.

In some implementations, the information of the target service type may be used to indicate the target service type, for example, the information of the target service type may be an index of the target service type.

Taking the third information including information of a target service as an example, the target service may be, for example, a service to which the sidelink data belongs. In some implementations, the information of the target service is used to indicate the target service, for example, the information of the target service may be an index of the target service.

Taking the third information including information of a target application type as an example, the target application type may be, for example, an application type of an application to which the sidelink data belongs. In some implementations, the information of the target application type may be used to indicate the target application type, for example, the information of the target application type may be an index of the target application type.

Taking the third information including information of a target application as an example, the target application may be, for example, an application type of an application to which the sidelink data belongs. In some implementations, the information of the target application is used to indicate the target application, for example, the information of the target application may be an index of the target application.

Taking the third information including Layer 2 information as an example, the Layer 2 information may be, for example, associated with sidelink data, and in some implementations, the Layer 2 information may be configured to indicate a communication device that performs transmission of the sidelink data through the Layer 2, for example, the Layer 2 information may include a Layer 2 index.

Taking the third information including information of a transmission configuration (Tx profile) as an example, the information of the transmission configuration may be associated with sidelink data, for example, and in some implementations, the information of the transmission configuration may be used to indicate a transmission configuration of the sidelink data. For example, the transmission configuration may include indication information of the transmission configuration. For another example, the transmission configuration may include a transmission configuration parameter of the first information.

Taking the third information including information of a target Quality of Service (QoS) flow as an example, the target QoS flow may be, for example, a QoS flow in which the sidelink data is located, and in some implementations, the information of the target QoS flow may be used to indicate the target QoS flow. For example, the information of the target QoS flow may include an identifier of the target QoS flow.

Taking the third information including information of a data transmission type as an example, the data transmission type may be, for example, a data transmission type of sidelink data, where the data transmission type may include one or more of unicast, multicast, and broadcast. In some implementations, the information of the data transmission type may be used to indicate the data transmission type. For example, the information of the data transmission type may include an identifier of the data transmission type.

In some implementations, the second carrier is determined based on a first association relationship between the second carrier and the third information. That is to say, the carrier associated with the third information of the first terminal device may be determined by establishing an association relationship between carriers and the third information, and a carrier associated with the third information of the first terminal device is the second carrier.

In some implementations, the first association relationship may be an association relationship between third information and carrier indication information, where the carrier indication information may be an index of a carrier, a sequence number of a carrier, or the like. Taking the third information including the information of the target service type as an example, the first association relationship may include an association relationship between information of target service types and indication information of carriers. Taking the third information including the information of the target service as an example, the first association relationship may include an association relationship between information of target services and indication information of carriers. Taking the third information including the information of the target application type as an example, the first association relationship may include an association relationship between information of target application types and indication information of carriers. Taking the third information including the Layer 2 information as an example, the first association relationship may include an association relationship between Layer 2 information and indication information of carriers. Taking the third information including the transmission configuration as an example, the first association relationship may include an association relationship between transmission configurations and indication information of carriers. Taking the third information including the information of the target QoS flow as an example, the first association relationship may include an association relationship between information of target QoS flows and indication information of carriers. Taking the third information including the data transmission type as an example, the first association relationship may include an association relationship between information of data transmission types and indication information of carriers.

It should be noted that the carrier(s) associated with the third information in the first association relationship may be one or more available carriers, that is to say, the third information in the first association relationship may be associated with a set of carriers, and the set of carriers may include one or more available carriers. For example, the second carrier belongs to a first set of carriers, and the first association relationship includes an association relationship between the first set of carriers and the third information, and the first set of carriers includes one or more carriers available for transmission of the second information.

Further, in the embodiment of the present disclosure, the available carrier(s) associated with the third information of the first terminal device may include a carrier carrying the second information (feedback information), that is, the second carrier. In this case, the carrier carrying the feedback information is also referred to as a “feedback carrier”.

In some implementations, the first association relationship may be defined by an upper layer of the first terminal device and/or the second terminal device, or the first association relationship may be applied to an upper layer of the first terminal device and/or the second terminal device. For example, the first association relationship may be defined by the NAS. For another example, the first association relationship may be defined by a V2X layer. For another example, the first association relationship may be defined by a proximity-based services (ProSe) layer.

It should be noted that the first carrier may be determined based on an association relationship between the third information and the first carrier, and the association relationship is established in a manner similar to the manner of establishing the first association relationship above, and the description thereof will not be repeated herein for the sake of brevity.

In some scenarios, after the available carrier(s) of the second information is/are determined, it is also necessary to determine a sidelink resource for transmission of the second information (or a time-frequency resource for transmission of the second information) and/or the second carrier. In some implementations, the time-frequency resource for transmission of the second information belongs to a second resource pool corresponding to the second carrier, and the second resource pool and/or the second carrier is determined based on the fourth information.

In some implementations, the fourth information includes one or more of: information of the first carrier, the information of the target QoS flow, information of a logical channel, information of a first resource pool, information of a target radio bearer, a target data priority, a congestion degree of the first resource pool, and predefined information.

Taking the fourth information including the information of the first carrier as an example, the first carrier is a carrier for transmission of sidelink data, thus the first carrier may also be referred to as a “data transmission carrier”. In some implementations, the information of the first carrier may be used to indicate the first carrier, for example, the information of the first carrier may be a sequence number of the first carrier.

Taking the fourth information including the information of the logical channel as an example, the logical channel may be, for example, a logical channel on which the sidelink data is located. In some implementations, the information of the logical channel may be used to indicate the logical channel. For example, the information of the logical channel may include an identifier of the logical channel.

Taking the fourth information including the information of the first resource pool as an example, the first resource pool may be, for example, a resource pool for transmission of the sidelink data. In some implementations, the information of the first resource pool may be used to indicate the first resource pool. For example, the information of the first resource pool may include an identifier of the first resource pool.

Taking the fourth information including the information of the target radio bearer as an example, the target radio bearer may be, for example, a radio bearer for transmission of the sidelink data. In some implementations, the information of the target radio bearer may be used to indicate the target radio bearer. For example, the information of the target radio bearer may include an identifier of the target radio bearer.

Taking the fourth information including the information of the target data priority as an example, the target data priority may be, for example, a data priority of the sidelink data. In some implementations, the information of the target data priority may be used to indicate the data priority of the sidelink data. For example, the information of the target data priority may include a level of the target data priority. For another example, the information of the target data priority may include an identifier of the target data priority.

Taking the fourth information including the congestion degree of the first resource pool as an example, the first resource pool may be, for example, a resource pool for transmission of the sidelink data. In some implementations, the congestion degree of the first resource pool may be determined by a Channel Busy Ratio (CBR) of the first resource pool.

Taking the fourth information including the predefined information as an example, in some implementations, the predefined information may be used to indicate one or more available carriers, where the available carrier may be understood as a carrier available for transmission of the sidelink data. In other implementations, the predefined information may be used to indicate one or more available resource pools, where the available resource pool may be understood as a resource pool available for transmission of the sidelink data.

It is to be noted that the predefined information may be replaced with pre-configured information, and the pre-configured information may be pre-configured by the network device. Of course, the predefined information may be replaced with default information, that is to say, the available carrier and/or the available resource pool may be the default.

In some implementations, the second resource pool is determined based on a second association relationship. The second association relationship includes an association relationship between the second resource pool and the second carrier, and an association relationship between the second carrier and the fourth information. Of course, in an embodiment of the present disclosure, the second association relationship may also include an association relationship between the second resource pool and the fourth information. That is to say, the carrier associated with the fourth information of the first terminal device and a resource pool within the carrier may be determined by establishing a second association relationship. A carrier associated with the fourth information of the first terminal device is the second carrier, and a resource pool associated with the fourth information of the first terminal device is the second resource pool.

In some implementations, the second association relationship may include an association relationship between the second carrier and the fourth information, where the second carrier may be represented by indication information of the second carrier. That is to say, the carrier in the second association relationship may be represented as an index of the carrier, a serial number of the carrier, and the like. Taking the fourth information including the information of the first carrier as an example, the second association relationship may include an association relationship between information of the first carriers and indication information of carriers. Taking the fourth information including the information of the target QoS flow as an example, the second association relationship may include an association relationship between information of target QoS flows and indication information of carriers. Taking the fourth information including the information of the logical channel as an example, the second association relationship may include an association relationship between information of logical channels and indication information of carriers. Taking the fourth information including the information of the first resource pool as an example, the second association relationship may include an association relationship between information of the first resource pools and indication information of carriers. Taking the fourth information including the information of the target radio bearer as an example, the second association relationship may include an association relationship between information of target radio bearers and indication information of carriers. Taking the fourth information including the target data priority as an example, the second association relationship may include an association relationship between target data priorities and indication information of carriers. Taking the fourth information including the congestion degree of the first resource pool as an example, the second association relationship may include an association relationship between congestion degrees of the first resource pools and indication information of carriers.

It should be noted that the carrier(s) associated with the fourth information in the second association relationship may be one or more available carriers, that is to say, the fourth information in the second association relationship may be associated with a set of carriers (also referred to as “second set of carriers”), and the set of carriers may include one or more available carriers. That is to say, the second association relationship may include an association relationship between the second resource pool and the second set of carriers, and an association relationship between the second set of carriers and the fourth information, where the second set of carriers includes one or more carriers available for transmission of the second information.

Further, in the embodiment of the present disclosure, the available carrier(s) associated with the fourth information of the first terminal device may include a carrier carrying the second information (fourth sidelink data), that is, the second carrier. At this time, the carrier carrying the fourth sidelink data is also referred to as a “feedback carrier”.

In some implementations, the second association relationship may be defined by an Access Stratum (AS) of the first terminal device and/or the second terminal device, or the second association relationship may be applied to the AS of the first terminal device and/or the second terminal device. Of course, in the embodiment of the present disclosure, the second association relationship may be defined by another layer, and the embodiment of the present disclosure is not limited thereto.

It should be noted that the resource pool for transmission of the fourth sidelink data may be determined based on an association relationship between the fourth information and the first carrier, and the association relationship is established in a manner similar to the manner of establishing the second association relationship above, and the description thereof will not be repeated herein for the sake of brevity.

The scheme of determining the second carrier in the embodiment of the present disclosure is described above based on the third information and the fourth information. Hereinafter, the scheme of determining the second carrier in the embodiment of the present disclosure will be described based on fifth information.

In some implementations, the second carrier is determined based on one or more of the following fifth information, and determining based on the fifth information may include, for example, obtaining by calculation based on the fifth information. The fifth information includes one or more of: Layer 2 information, a frequency domain resource of the first information, configuration information of a first resource pool, and configuration information of a second resource pool.

Taking the fifth information including Layer 2 information as an example, the Layer 2 information may be, for example, associated with the third sidelink data, and in some implementations, the Layer 2 information may be configured to indicate a communication device that performs transmission of the third sidelink data through the Layer 2, for example, the Layer 2 information may include a Layer 2 index.

Taking the fifth information including the frequency domain resource of the first information as an example, the frequency domain resource of the first information may be a frequency domain resource for transmission of the first information. Herein, the frequency domain resource may include, for example, a Resource Element (RE), a subcarrier, a carrier, and the like.

Taking the fifth information including the configuration information of the first resource pool as an example, the configuration information of the first resource pool includes one or more configuration parameters for configuring the first resource pool, for example, parameters such as a PSFCH period, a number of sub-channels, and a number of Physical Resource Blocks (PRBs) that can be used for PSFCH transmission. Further, since the first resource pool is used for transmission of the first information, the first resource pool is also referred to as a “data transmission resource pool”.

Taking the fifth information including the configuration information of the second resource pool as an example, the configuration information of the second resource pool includes one or more configuration parameters for configuring the second resource pool, for example, parameters such as a PSFCH period, a number of sub-channels, and a number of PRBs that can be used for PSFCH transmission. Further, since the second resource pool is used for transmission of the second information, the second resource pool is also referred to as a “feedback transmission resource pool”.

It is to be noted that in the embodiment of the present disclosure, the above-described information included in the fifth information may be pre-configured, configured by a network device, or predetermined. Taking the fifth information being configured by the network device as an example, the network device may configure the fifth information through dedicated signaling or a system message. Of course, in the embodiment of the present disclosure, the fifth information may be configured by other information.

Further, in some scenarios, the fifth information may include a plurality of pieces of information described above, and at this time, the second carriers determined based on different information may be different. Then, in this case, the information of the second carrier may be determined by predefinition, pre-configuration, or negotiation between the first terminal device and the second terminal device. For example, the fifth information includes configuration information of the first resource pool and configuration information of the second resource pool, and at this time, the second carrier determined based on the configuration information of the first resource pool may be different from the second carrier determined based on the configuration information of the second resource pool. In this case, a resource pool configuration may indicate whether the second carrier is determined based on the configuration information of the first resource pool or the configuration information of the second resource pool. Alternatively, predefinition in a protocol may indicate whether the second carrier is determined based on the configuration information of the first resource pool or the configuration information of the second resource pool. Alternatively, the first terminal device may negotiate with the second terminal device to determine whether the second carrier is determined based on the configuration information of the first resource pool or the configuration information of the second resource pool.

In the above-described scheme involving negotiation between the first terminal device and the second terminal device, the embodiment of the present disclosure does not limit the signaling used for negotiation between the first terminal device and the second terminal device, and for example, the signaling used for negotiation between the first terminal device and the second terminal device may be carried in one or more of: PC5-Radio Resource Control (RRC) signaling, an Media Access Control Control Element (MAC CE), and Sidelink Control Information (SCI). For example, if the first terminal device and the second terminal device communicate in a unicast manner, signaling used for negotiation between the first terminal device and the second terminal device may be carried in one or more of: PC5-RRC signaling, MAC CE, and SCI.

Of course, in the embodiment of the present disclosure, the carrier(s) determined based on the fifth information may include one or more available carriers, and at this time, one carrier may be selected, according to a preset rule or randomly from the available carriers, as the second carrier for transmission of the second information. That is to say, the second carrier belongs to a third set of carriers, and the third set of carriers is determined based on the fifth information, where the third set of carriers includes one or more carriers available for transmission of the second information.

The manner for determining the second carrier is described above based on the third information, the fourth information and the fifth information, respectively. In the embodiment of the present disclosure, the above-described manner for determining the second carrier may be used alone. Of course, in the embodiment of the present disclosure, the above-described manners for determining the second carrier may be used in combination with each other, for example, the third information and the fourth information may be used to establish an association relationship with the available carriers, and then the second carrier may be selected from the available carriers. For another example, the fourth information and the fifth information may be used to establish an association relationship with the available carriers, and then the second carrier may be selected from the available carriers. For another example, the third information and the fifth information may be used to establish an association relationship with the available carriers, and then the second carrier may be selected from the available carriers. The combination manner of the above three types of information may be pre-configured, predefined, configured by a network device, or determined through negotiation between the first terminal device and the second terminal device, and the embodiment of the present disclosure is not limited thereto.

In addition, in the embodiment of the present disclosure, the various association relationships (for example, the first association relationship, the second association relationship, and the third association relationship) described above may be applied to a scenario of unicast communication between the first terminal device and the second terminal device, or to a scenario of multicast communication between the first terminal device and the second terminal device, or to a scenario of broadcast communication between the first terminal device and the second terminal device.

In some implementations, the first terminal device may further indicate the second carrier to the second terminal device in a dynamic indication manner. That is to say, the method further includes: the first terminal device sends first indication information to the second terminal device, the first indication information being used to indicate the second carrier. Herein, the first indication information may be carried in first-stage SCI and/or second-stage SCI; and of course, the first indication information may also be dedicated information that is independently transmitted, which is not limited in the embodiment of the present disclosure.

In some implementations, the first indication information includes one or more of: indication information of the second carrier; indication information of a second resource pool; indication information of a time domain resource for transmission of the second information; and indication information of a frequency domain resource for transmission of the second information.

The indication information of the second carrier may include, for example, an identifier of the second carrier, a sequence number of the second carrier, and the like. In some implementations, the indication information of the second carrier may include a carrier indication.

For the indication information of the second resource pool, the second resource pool is used for transmission of the second information (i.e., fourth sidelink data). The indication information of the second resource pool is also referred to as a second resource pool indication.

The indication information of the time domain resource for transmission of the second information is also referred to as indication information of a time domain resource available for transmission of the second information. Herein, the indication information of the time domain resource is also referred to as an indication of the time domain resource, and for example, the indication information of the time domain resource may include an index of a symbol for transmission of the second information.

The indication information of the frequency domain resource for transmission of the second information is also referred to as indication information of a frequency domain resource available for transmission of the second information. Herein, the indication information of the frequency domain resource is also referred to as an indication of the frequency domain resource, and for example, the indication information of the frequency domain resource may include an index of a symbol for transmission of the second information.

It is to be noted that the above scheme for dynamically indicating the second carrier may also be applied to dynamically indicating the first carrier, and the specific indicating method is similar to the above scheme for indicating the second carrier. Detailed description will not be repeated here for the sake of brevity.

In some implementations, the first terminal device and the second terminal device may determine the first carrier and/or the second carrier through negotiation therebetween. Or in other words, the first carrier and/or the second carrier is determined based on negotiation between the first terminal device and the second terminal device.

In some implementations, the negotiation may be performed through capability interaction between the first terminal device and the second terminal device. The capability interaction may be indication of the capability information of the first terminal device by the first terminal device to the second terminal device. That is to say, the method further includes: the first terminal device sends the capability information of the first terminal device to the second terminal device, where the capability information of the first terminal device is used to indicate a carrier supported by the first terminal device and/or a number of carriers supported by the first terminal device.

The capability interaction may be indication of the capability information of the second terminal device by the second terminal device to the first terminal device. That is to say, the method further includes: the second terminal device sends the capability information of the second terminal device to the first terminal device, where the capability information of the second terminal device is used to indicate a carrier supported by the second terminal device and/or a number of carriers supported by the second terminal device.

Of course, in the embodiment of the present disclosure, the capability interaction may include indication of the capability information of the first terminal device by the first terminal device to the second terminal device, and indication of the capability information of the second terminal device by the second terminal device to the first terminal device. The embodiment of the present disclosure does not limit the sequence of transmission of the capability information of the first terminal device and the capability information of the second terminal device. For example, transmission of the capability information of the first terminal device may be performed before transmission of the capability information of the second terminal device. For another example, transmission of the capability information of the second terminal device may be performed before transmission of the capability information of the first terminal device. For another example, transmission of the capability information of the second terminal device may be performed simultaneously with transmission of the capability information of the first terminal device.

In some implementations, the first terminal device may determine the first carrier and/or the second carrier based on the capability information of the first terminal device and the capability information of the second terminal device. For example, when the capability information of the first terminal device indicates that carriers supported by the first terminal device are carriers 1 to 3, and the capability information of the second terminal device indicates that carriers supported by the second terminal device are carriers 2 to 3, then the first terminal device may select the carriers 2 to 3 as the first carrier and the second carrier. Of course, in the embodiment of the present disclosure, the second terminal device may determine the first carrier and/or the second carrier based on the capability information of the first terminal device and the capability information of the second terminal device. Alternatively, in the embodiment of the present disclosure, the second terminal device determines the second carrier based on the capability information of the first terminal device and the capability information of the second terminal device, and the first terminal device determines the first carrier based on the capability information of the first terminal device and the capability information of the second terminal device. Alternatively, the second terminal device determines the first carrier based on the capability information of the first terminal device and the capability information of the second terminal device, and the first terminal device determines the second carrier based on the capability information of the first terminal device and the capability information of the second terminal device.

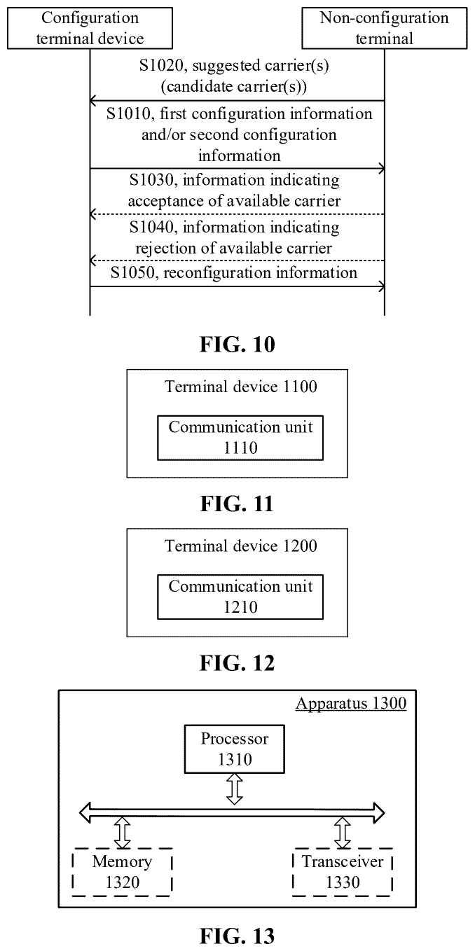

In some implementations, the negotiation may be implemented by one or more signaling interactions between the first terminal device and the second terminal device. In order to facilitate understanding, description will be made below with reference to FIG. 10. For example, the signaling may include first configuration information, that is, the method further includes: the first terminal device sends the first configuration information to the second terminal device (see operation S1010), where the first configuration information is used to configure the first carrier and/or the second carrier for the second terminal device.

In some implementations, the first configuration information is used to configure a fourth set of carriers, where the fourth set of carriers includes one or more carriers available for transmission of the first information and/or the second information. Of course, in the embodiment of the present disclosure, the first configuration information may be used to directly configure the first carrier and/or the second carrier.

In the embodiment of the present disclosure, the first configuration information may be carried in PC5-RRC signaling; of course, in the embodiment of the present disclosure, the first configuration information may also be carried in dedicated signaling, and the embodiment of the present disclosure is not limited thereto.

For example, the signaling may include second configuration information, that is, the method further includes: the second terminal device sends the second configuration information to the first terminal device (see operation S1010), where the second configuration information is used to configure the first carrier and/or the second carrier for the first terminal device.

In the embodiment of the present disclosure, the second configuration information may be carried in PC5-RRC signaling; of course, in the embodiment of the present disclosure, the first configuration information may also be carried in dedicated signaling, and the embodiment of the present disclosure is not limited thereto.

In some implementations, the second configuration information is used to configure a fourth set of carriers, where the fourth set of carriers includes one or more carriers available for transmission of the first information and/or the second information. Of course, in the embodiment of the present disclosure, the second configuration information may be used to directly configure the first carrier and/or the second carrier.

For convenience of description, the terminal device that sends the first configuration information and/or the second configuration information is referred to as a “configuration terminal”, and the terminal device that receives the first configuration information and/or the second configuration information is referred to as a “non-configuration terminal”. That is to say, for the first configuration information, the configuration terminal is the first terminal device, and the non-configuration terminal is the second terminal device. For the second configuration information, the configuration terminal is the second terminal device, and the non-configuration terminal is the first terminal device.

In some scenarios, the non-configuration terminal may send a suggested carrier to the configuration terminal (see operation S1020) to improve the rationality of the configuration of the carrier by the configuration terminal. That is to say, before transmission of the first configuration information and/or the second configuration information is performed, the non-configuration terminal may send second indication information to the configuration terminal device, where the second indication information is used to indicate an available carrier (also referred to as a “candidate carrier”) suggested by the non-configuration terminal. The candidate carrier is used by the configuration terminal device to configure the first carrier and/or the second carrier.

In some scenarios, after the non-configuration terminal device receives the available carrier configured by the configuration terminal device, the available carrier may not be suitable, then the non-configuration terminal device may reject the available carrier. Of course, if the available carrier is suitable, the non-configuration terminal device may accept the available carrier.

If the non-configuration terminal device accepts the available carrier, the non-configuration terminal may send information indicating acceptance of the available carrier to the configuration terminal (see operation S1030). Of course, in the embodiment of the present disclosure, the non-configuration terminal may not send the information indicating acceptance of the available carrier to the configuration terminal, and accordingly, if the non-configuration terminal uses the available carrier within a preset time, it may be determined that the non-configuration terminal accepts the available carrier.

If the non-configuration terminal rejects the available carrier, the non-configuration terminal may send information indicating the rejection of the available carrier to the configuration terminal (see operation S1040). Of course, in the embodiment of the present disclosure, the non-configuration terminal may not send the information indicating rejection of the available carrier to the configuration terminal, and accordingly, if the non-configuration terminal does not use the available carrier after a preset time, it may be determined that the non-configuration terminal device rejects the available carrier.

In some scenarios, if the non-configuration terminal rejects the available carrier, the configuration terminal may send reconfiguration information to the non-configuration terminal (see operation S1050), where the reconfiguration information is used to reconfigure the first carrier and/or the second carrier for the non-configuration terminal.

In some implementations, the reconfiguration process may be considered to have failed if a preset condition is met. The preset condition may be related to a number of times that the configuration terminal configures the first carrier and/or the second carrier for the non-configuration terminal, and/or the preset condition may be related to a length of time taken by the configuration terminal to configure the first carrier and/or the second carrier for the non-configuration terminal.

For example, if the preset condition is related to the number of times that the configuration terminal configures the first carrier and/or the second carrier for the non-configuration terminal, the preset condition may include: the number of times that the configuration terminal configures the first carrier and/or the second carrier for the non-configuration terminal is greater than a threshold value.

For another example, if the preset condition is related to the length of time taken by the configuration terminal to configure the first carrier and/or the second carrier for the non-configuration terminal, the preset condition may include: the length of time taken by the configuration terminal to configure the first carrier and/or the second carrier for the non-configuration terminal is longer than a threshold value.

It is to be noted that in the embodiment of the present disclosure, the reason why the non-configuration terminal rejects the available carrier is not limited. For example, assuming that the non-configuration terminal is a terminal device 1, and the configuration terminals include a terminal device 2 and a terminal device 3, then the terminal device 2 configures the terminal device 1 to send feedback information on the carrier 2, and the terminal device 3 configures the terminal device 1 to send feedback information on the carrier 3. At this time, the terminal device 1 needs to send feedback information on the carrier 2 and the carrier 3 respectively, resulting in a large power consumption of the terminal device 1, then the terminal device 1 may reject the configuration by the terminal device 3.

Further, the first configuration information and/or the second configuration information may be determined based on the candidate carrier(s) indicated by the non-configuration terminal. In the embodiment of the present disclosure, the first configuration information and/or the second configuration information may be independently determined by the configuration terminal, and the embodiment of the present disclosure is not limited thereto.

In some implementations, any of the configuration processes described above may be used in conjunction with dynamic activation. That is to say, after the available carrier configured by the first configuration information and/or the second configuration information is configured to the non-configuration terminal, the configuration terminal may send third instruction information to the non-configuration terminal to indicate whether to activate the configured available carrier. In other words, the third indication information is used to indicate whether transmission of the second information is allowed to be performed through the second carrier.

For example, the terminal device 1 configures the set A of carriers for the terminal device 2, at this time, the set A of carriers includes one or more available carriers associated with the second information, and then the terminal device 1 may send the indication information 3 to the terminal device 2 to indicate a carrier in the set A of carriers, which can be used for transmission of the second information.

In the embodiment of the present disclosure, the manner by which the third indication information is carried is not limited. For example, the third indication information may be carried in an MAC CE. For another example, the third indication information may be carried in SCI.

In some implementations, whether transmission of the second information is performed through the second carrier is determined based on one or more of: whether a carrier available for transmission of the second information exists; a QoS parameter associated with the first information; a quality of communication between the first terminal device and the second terminal device; and a resource congestion condition of resources available for transmission of the second information.

If whether transmission of the second information is performed through the second carrier is determined based on whether the carrier available for transmission of the second information exists, in some implementations, if the carrier available for transmission of the second information exists, the transmission of the second information may be performed through the second carrier. In other implementations, if the carrier available for transmission of the second information does not exist, the transmission of the second information is not performed through the second carrier.

For example, if there is only a second carrier (i.e. cross-carrier feedback resource) and there are no resources available for PSFCH in the current resource pool, the transmission of the second information may be performed through the second carrier (i.e. using cross-carrier feedback). For another example, if there is a second carrier (i.e., cross-carrier feedback resource) and there are resources available for PSFCH in the current resource pool, the transmission of the second information may not be performed through the second carrier (i.e., using cross-carrier feedback). For another example, if there is no second carrier (i.e., cross-carrier feedback resource) and there are resources available for PSFCH in the current resource pool, the transmission of the second information may not be performed through the second carrier (i.e., using cross-carrier feedback).

If whether transmission of the second information is performed through the second carrier is determined based on the QoS parameter associated with the first information, in some implementations, if the QoS parameter associated with the first information has higher requirement, the transmission of the second information may be performed through the second carrier. In other implementations, if the QoS parameter associated with the first information has lower requirement, the transmission of the second information is not performed through the second carrier.

Alternatively, in other implementations, if the QoS parameter associated with the first information has lower requirement, the transmission of the second information may be performed through the second carrier. In other implementations, if the QoS parameter associated with the first information has higher requirement, the transmission of the second information is not performed through the second carrier.

For example, the QoS parameter includes a transmission delay, and if the transmission delay associated with the first information is less than a threshold value, the transmission of the second information may be performed through the second carrier. Conversely, if the transmission delay associated with the first information is greater than the threshold value, the transmission of the second information is not performed through the second carrier.

For another example, the QoS parameter includes a Packet Error Rate (PER), and if the PER associated with the first information is greater than a threshold value, the transmission of the second information may be performed through the second carrier. Conversely, if the PER associated with the first information is less than the threshold value, the transmission of the second information is not performed through the second carrier.

If whether transmission of the second information is performed through the second carrier is determined based on the communication quality, in some implementations, if the communication quality is higher, the transmission of the second information may be performed through the second carrier. In other implementations, if the communication quality is lower, the transmission of the second information is not performed through the second carrier. Alternatively, in some implementations, if the communication quality is higher, the transmission of the second information may not be performed through the second carrier. In other implementations, if the communication quality is lower, the transmission of the second information is performed through the second carrier.

For example, the communication quality is determined based on a packet loss rate, and if the packet loss rate is lower than a threshold value, the transmission of the second information may be performed through the second carrier. Conversely, if the packet loss rate is higher than the threshold value, the transmission of the second information is not performed through the second carrier.

For example, the communication quality is determined based on a receiving status of feedback information, and if the receiving status of the feedback information indicates activation once feedback information has not been received for x consecutive times, and x is higher than a threshold value, then the transmission of the second information may be performed through the second carrier. Conversely, if the receiving status of the feedback information indicates activation once feedback information has not been received for x consecutive times, and x is lower than the threshold value, then the transmission of the second information is not performed through the second carrier, where x is a positive integer.

If whether transmission of the second information is performed through the second carrier is determined based on the resource congestion condition, in some implementations, if the resource congestion condition is severe (e.g., the CBR is above a threshold value), the transmission of the second information may not be performed through the second carrier. In other implementations, if the resource congestion condition is not severe (e.g., the CBR is below the threshold value), the transmission of the second information is performed through the second carrier.

Of course, in the embodiment of the present disclosure, whether transmission of the second information is performed through the second carrier can further be determined by other means. In some implementations, whether transmission of the second information is performed through the second carrier may be determined based on a preset rule.

In other implementations, whether transmission of the second information is performed through the second carrier may be determined based on an upper layer (e.g., Non Access Stratum (NAS)) indication. For example, whether transmission of the second information is performed through the second carrier may be determined based on third information, where for description of the third information, reference can be made to the above, which will not be repeated for the sake of brevity. For another example, whether transmission of the second information is performed through the second carrier may be determined based on a first association relationship associated with the third information, where for description of the first association relationship, reference can be made to the above, which will not be repeated for the sake of brevity.

In other implementations, whether transmission of the second information is performed through the second carrier may be determined based on an AS configuration. Activation of the AS configuration may be configured, for example, per bearer; or activation of the AS configuration may be configured, for example, per Logical Channel (LCH); or activation of the AS configuration may be configured, for example, per link; or activation of the AS configuration may be configured, for example, per sidelink grant; or activation of the AS configuration may be configured, for example, per Configured Grant (CG). The AS configuration may be configured by a network device or another terminal device.

In other implementations, whether transmission of the second information is performed through the second carrier may be determined based on dynamic indication (or indication information). Herein, the indication information may be configured by a network device or another terminal device. Further, the indication information may be carried in one or more of the following: MAC CE, SCI, and Downlink Control Information (DCI).

The determination of whether transmission of the second information is performed through the second carrier may be performed by the first terminal device or the second terminal device. Of course, in the embodiment of the present disclosure, the determination of whether transmission of the second information is performed through the second carrier may also be determined by the network device, and the embodiment of the present disclosure is not limited thereto.

In some scenarios, if the cross-carrier feedback scheme according to the embodiment of the present disclosure is adopted, the second terminal device may send the second information through a plurality of carriers, which is helpful to improve the reliability of transmission of the second information. That is to say, the second carrier is one of the plurality of carriers, and the operation that the first terminal device receives, through the second carrier, the second information sent by the second terminal device includes: the first terminal device receives, through the plurality of carriers, the second information sent by the second terminal device; or, the second carrier is one of the plurality of carriers, the second information is one of a plurality of pieces of second information, and transmission of the plurality of pieces of second information is performed through the plurality of carriers respectively.

It is to be noted that the second terminal device may perform transmission of the second information a plurality of times through some or all of the plurality of carriers. Of course, in the embodiment of the present disclosure, the second terminal device may perform transmission of the second information once through some or all of the plurality of carriers, and the embodiment of the present disclosure is not limited thereto.

In the conventional third sidelink data transmission scheme, if transmission of the third sidelink data is performed through the carrier 1, the fourth sidelink data is also fed back through the carrier 1 accordingly. In this scenario, it is usually determined whether a Radio Link Failure (RLF) occurs in the communication link by counting the number of times that reception of the fourth sidelink data on the carrier 1 fails. However, in the above-described scenario in which transmission of the second information is performed through a plurality of carriers, how to determine whether the communication link has failed is an urgent problem to be solved.

Therefore, in view of the problem above, an embodiment of the present disclosure proposes to determine, based on information that is not successfully received in a target carrier, whether RLF occurs on the radio link for transmission of the first information. That is to say, whether the RLF occurs on the radio link for transmission of the first information is determined based on the information that is not successfully received in the target carrier. For example, whether the RLF occurs may be determined based on the number of unsuccessful receptions of the information in the target carrier. For another example, whether the RLF occurs may be determined based on a duration of unsuccessful receptions of the information in the target carrier.

In some implementations, the target carrier includes a plurality of carriers and a first carrier. For example, counters (denoted by “numDTX”) may be set for a plurality of carriers and a first carrier respectively, and if the fourth sidelink data on a certain carrier is not received, the counters corresponding to the plurality of carriers and the first carrier are incremented by 1 until counts of the counters are greater than or equal to a threshold value, then it can be determined that the wireless link for transmission of the first information fails.

In some implementations, the target carrier is one of the plurality of carriers. For example, a counter (represented by “numDTX”) may be set for the target carrier, and if the fourth sidelink data on the target carrier is not received, the counter corresponding to the target carrier is incremented by 1 until the count of the counter is greater than or equal to the threshold value, then it can be determined that the wireless link for transmission of the first information fails.

The target carrier is not limited in the embodiment of the present disclosure. For example, the target carrier may be any one of a plurality of carriers. For another example, the target carrier may be a carrier with the highest priority among the plurality of carriers. For another example, the target carrier may be a primary carrier among the plurality of carriers.

Further, the determination manner of the target carrier is not limited in the embodiment of the present disclosure. For example, the target carrier may be determined by the first terminal device. For another example, the target carrier may be determined by the second terminal device. For another example, the target carrier may be determined through negotiation between the first terminal device and the second terminal device. For another example, the target carrier may be predefined. For another example, the target carrier may be pre-configured. For another example, the target carrier may be determined based on a resource pool configuration. For another example, the target carrier may be determined based on a carrier configuration. For another example, the target carrier may be configured by a network.

Currently, in a conventional Sidelink Discontinuous Reception (SL DRX) mechanism, the starting of a first timer (e.g., a Round-Trip Time (RTT) timer and/or a retransmission timer) associated with the SL DRX mechanism is determined based on PSFCH resources. Then, in the cross-carrier feedback scenario proposed in the embodiment of the present disclosure, how to determine the starting of the timer is an urgent problem to be solved.

Therefore, in view of the problem above, the embodiment of the present disclosure proposes to determine starting of the first timer based on one or more of: a PSFCH resource on the first carrier; a PSFCH resource with a latest time domain position among a plurality of carriers; a PSFCH resource on a carrier having a highest priority among the plurality of carriers; and a PSFCH resource on a primary carrier of the plurality of carriers. Of course, one PSFCH resource may be randomly selected for the determination, and this is not limited in the embodiment of the present disclosure.

If the starting of the first timer is determined based on the PSFCH resource with the latest time domain position among the plurality of carriers, the plurality of carriers are carriers for transmission of the second information, and the plurality of carriers include the second carrier.

In some implementations, the first timer is used to determine a round-trip time for transmission of the first information, and may be, for example, a RTT timer. In other implementations, the first timer is used to determine a retransmission time of the first information, and may be, for example, a retransmission timer.

It is to be noted that determining the starting of the first timer based on the PSFCH resource may include: the starting time of the first timer is a time domain position of the PSFCH resource, or the starting time of the first timer is determined based on the time domain position of the PSFCH resource and a time domain offset value. The time domain position of the PSFCH resource may include a start time domain position of the PSFCH resource, an end time domain position of the PSFCH resource, or a certain time domain position of the PSFCH resource.

In a second embodiment, it is assumed that the second information includes first sidelink data, and the first information includes first sidelink control information for scheduling the first sidelink data. In other words, the second information is carried in a second Physical Sidelink Shared Channel (PSSCH), and the first information is carried in a first Physical Sidelink Control Channel (PSCCH) for scheduling the second PSSCH.

In some implementations, the first sidelink control information may be used to schedule second sidelink data on the first carrier and first sidelink data transmitted on the second carrier, that is to say, the first information further includes the second sidelink data scheduled by the first sidelink control information. In other words, the first sidelink control information may be used to schedule the second PSSCH on the first carrier and a first PSSCH transmitted on the second carrier, that is to say, the first information further includes sidelink data carried in the second PSSCH.

In other implementations, the first sidelink control information (e.g., first-stage SCI) may be used to schedule the second sidelink data on the first carrier, and the first sidelink data and the second sidelink control information (e.g., second-stage SCI) transmitted on the second carrier, that is to say, the second information further includes the second sidelink control information scheduled by the first sidelink control information. In other words, the first sidelink control information may be used to schedule a second PSSCH on the first carrier and a first PSSCH transmitted on the second carrier, where the first PSSCH includes the second sidelink control information and the first sidelink data.

In some scenarios, in order to prevent a terminal device that does not support the cross-carrier transmission scheme from being unable to recognize the first information and the second information, a first resource pool may be set for transmission of the first information, and a second resource pool may be set for transmission of the second information.

Since the first resource pool is used for transmission of the PSCCH, the first resource pool is also referred to as a “PSCCH-only resource pool”. In other words, since the first resource pool is used for transmission of sidelink control information, the first resource pool is also referred to as an “SCI-only resource pool”. Herein, the PSCCH-only (or SCI-only) can be understood as its transmission is not performed together with transmission of sidelink data, or it is not used for transmission of the sidelink data.

Since the second resource pool is used for transmission of the PSSCH, the second resource pool is also referred to as a “PSSCH-only resource pool”. In other words, since the second resource pool is used for transmission of sidelink control information, the second resource pool is also referred to as a “data-only resource pool”, or a “payload-only resource pool”. Herein, the data-only (or payload-only) can be understood as its transmission is not performed together with transmission of sidelink control information, or it is not used for transmission of the sidelink control information.

It is to be noted that in the embodiment of the present disclosure, the first sidelink control information is different from the conventional sidelink control information, and the first sidelink control information of the embodiment of the present disclosure is used for cross-carrier scheduling. Accordingly, in some implementations, the first sidelink control information may adopt a specific SCI format (e.g., a newly introduced SCI format) in order to distinguish from conventional SCI. At this time, a resource pool may be set for transmission of the first sidelink control information. Transmission of only the first sidelink control information may be performed in the resource pool, or the resource pool may be used for transmission of the first sidelink control information, that is, it may be an example of the first resource pool described above. In addition, in the embodiment of the present disclosure, the first resource pool and the second resource pool may be also classified according to a dimension that it is used for transmission of sidelink control information or transmission of sidelink data. For example, the first resource pool is used for transmission of sidelink control information (including the first sidelink control information and/or the second sidelink control information). The second resource pool is used for transmission of third sidelink data (including first sidelink data and/or second sidelink data).

It should be noted that the sidelink data in the embodiment of the present disclosure may be initial transmission data or retransmission data. No limitations are imposed in this regard in the embodiments of the present disclosure.

As described above, the introduction of multiple resource pools may affect the resource detection process. In some implementations, a sidelink resource for transmission of the second information is determined based on a resource detection result, and accordingly, the resource detection result includes a resource detection result for the first resource pool and/or a resource detection result for the second resource pool.

If the resource detection result includes the resource detection result for the first resource pool, it can be understood that the resource detection is performed only in a resource pool (i.e., the first resource pool) associated with the PSCCH, and resource exclusion and/or resource selection is performed on resources in a scheduled resource pool (i.e., the second resource pool) according to the resource detection result.

If the resource detection result includes the resource detection result for the resource pool on the first carrier, it can be understood that the resource detection is performed only in the resource pool (i.e., the first resource pool) on the first carrier, and the resource exclusion and/or resource selection is performed on resources in a resource pool (i.e., the second resource pool) on the scheduled carrier according to the resource detection result.

Since the resource pool on the first carrier or the resource pool associated with the PSCCH can be used for transmission of the first sidelink control information, the resource pool may also be referred to as a “resource pool in which scheduling information is located”. Accordingly, since the second resource pool can be used for transmission of scheduled information, it may also be referred to as a “resource pool in which the scheduled information is located”.

Of course, in the embodiment of the present disclosure, resource detection may be performed in the first resource pool and the second resource pool simultaneously, and then resource exclusion and/or resource selection may be performed on the resources in the first resource pool based on the resource detection result for the first resource pool, and resource exclusion and/or resource selection may be performed on the resources in the second resource pool based on the resource detection result for the second resource pool. Alternatively, in the embodiment of the present disclosure, resource detection may be performed in the first resource pool and the second resource pool simultaneously, and then resource exclusion and/or resource selection may be performed on the resources in the first resource pool and the resources in the second resource pool based on the resource detection result for the first resource pool and the resource detection result for the second resource pool. That is to say, the resource detection result of the first resource pool and the resource detection result of the second resource pool may be comprehensively considered, to perform the resource exclusion and/or resource selection on the resources in the first resource pool and the resources in the second resource pool.

As described above, the transmission of the first information and the second information may be performed through different carriers, thus how to determine the second carrier used for transmission of the second information is an urgent problem to be solved. Therefore, in view of this problem, it is proposed in the embodiment of the present disclosure that the second carrier may be determined based on some information (hereinafter, also referred to as “third information”) shared by the first terminal device and the second terminal device.

That is to say, the second carrier may be determined based on third information, where the third information includes one or more of: information of a target service type, information of a target service, information of a target application type, information of a target application, Layer 2 information, a transmission configuration, and a data transmission type.

Taking the third information including information of a target service type as an example, the target service type may be, for example, a service type of a service to which the first sidelink control information belongs. Herein, the target service type may include, for example, a rate-prioritized service type, a reliability-prioritized service type, and the like, and the embodiment of the present disclosure is not limited thereto.

In some implementations, the information of the target service type may be used to indicate the target service type, for example, the information of the target service type may be an index of the target service type.

Taking the third information including information of a target service as an example, the target service may be, for example, a service to which the first sidelink control information belongs. In some implementations, the information of the target service is used to indicate the target service, for example, the information of the target service may be an index of the target service.

Taking the third information including information of a target application type as an example, the target application type may be, for example, an application type of an application to which the first sidelink control information belongs. In some implementations, the information of the target application type may be used to indicate the target application type, for example, the information of the target application type may be an index of the target application type.

Taking the third information including information of a target application as an example, the target application may be, for example, an application type of an application to which the first sidelink control information belongs. In some implementations, the information of the target application is used to indicate the target application, for example, the information of the target application may be an index of the target application.

Taking the third information including Layer 2 information as an example, the Layer 2 information may be, for example, associated with the first sidelink control information, and in some implementations, a communication device that performs transmission of the first sidelink control information through the Layer 2, for example, the Layer 2 information may include a Layer 2 index.

Taking the third information including information of a transmission configuration (Tx profile) as an example, the information of the transmission configuration may be associated with the first sidelink control information, for example, and in some implementations, the information of the transmission configuration may be used to indicate a transmission configuration of the first sidelink control information. For example, the transmission configuration may include indication information of the transmission configuration. For another example, the transmission configuration may include a transmission configuration parameter of the first information.

Taking the third information including information of a data transmission type as an example, the data transmission type may be, for example, a data transmission type of the first sidelink control information, where the data transmission type may include one or more of unicast, multicast, and broadcast. In some implementations, the information of the data transmission type may be used to indicate the data transmission type. For example, the information of the data transmission type may include an identifier of the data transmission type.

In some implementations, the second carrier is determined based on a first association relationship between the second carrier and the third information. That is to say, the carrier associated with the third information of the first terminal device may be determined by establishing an association relationship between carriers and the third information, and a carrier associated with the third information of the first terminal device is the second carrier.

In some implementations, the first association relationship may be an association relationship between third information and carrier indication information, where the carrier indication information may be an index of a carrier, a sequence number of a carrier, or the like. Taking the third information including the information of the target service type as an example, the first association relationship may include an association relationship between information of target service types and indication information of carriers. Taking the third information including the information of the target service as an example, the first association relationship may include an association relationship between information of target services and indication information of carriers. Taking the third information including the information of the target application type as an example, the first association relationship may include an association relationship between information of target application types and indication information of carriers. Taking the third information including the Layer 2 information as an example, the first association relationship may include an association relationship between Layer 2 information and indication information of carriers. Taking the third information including the transmission configuration as an example, the first association relationship may include an association relationship between transmission configurations and indication information of carriers. Taking the third information including the data transmission type as an example, the first association relationship may include an association relationship between information of data transmission types and indication information of carriers.

It should be noted that the carrier(s) associated with the third information in the first association relationship may be one or more available carriers, that is to say, the third information in the first association relationship may be associated with a set of carriers, and the set of carriers may include one or more available carriers. For example, the second carrier belongs to a first set of carriers, and the first association relationship includes an association relationship between the first set of carriers and the third information, and the first set of carriers includes one or more carriers available for transmission of the second information.

Further, in the embodiment of the present disclosure, the available carrier(s) associated with the third information of the first terminal device may include a carrier carrying the second information (i.e., first sidelink data), that is, the second carrier.

In some implementations, the first association relationship may be defined by an upper layer of the first terminal device and/or the second terminal device, or the first association relationship may be applied to an upper layer of the first terminal device and/or the second terminal device. For example, the first association relationship may be defined by the NAS. For another example, the first association relationship may be defined by a V2X layer. For another example, the first association relationship may be defined by a proximity-based services (ProSe) layer.

It should be noted that the first carrier may be determined based on an association relationship between the third information and the first carrier, and the association relationship is established in a manner similar to the manner of establishing the first association relationship above, and the description thereof will not be repeated herein for the sake of brevity.

In some scenarios, after the available carrier(s) of the second information is/are determined, it is also necessary to determine a sidelink resource for transmission of the second information (or a time-frequency resource for transmission of the second information) and/or the second carrier. In some implementations, the time-frequency resource for transmission of the second information belongs to a second resource pool corresponding to the second carrier, and the second carrier and/or the second resource pool is determined based on the fourth information.

In some implementations, the fourth information includes one or more of: information of the first carrier, the information of the target QoS flow, information of a logical channel, information of a first resource pool, information of a target radio bearer, a target data priority, a congestion degree of the first resource pool, and predefined information.

Taking the fourth information including the information of the first carrier as an example, the first carrier is a carrier for transmission of the first sidelink control information. In some implementations, the information of the first carrier may be used to indicate the first carrier, for example, the information of the first carrier may be a sequence number of the first carrier.

Taking the fourth information including the information of the logical channel as an example, the logical channel may be, for example, a logical channel on which the first sidelink control information is located. In some implementations, the information of the logical channel may be used to indicate the logical channel. For example, the information of the logical channel may include an identifier of the logical channel.

Taking the fourth information including the information of the first resource pool as an example, the first resource pool may be, for example, a resource pool for transmission of the first sidelink control information. In some implementations, the information of the first resource pool may be used to indicate the first resource pool. For example, the information of the first resource pool may include an identifier of the first resource pool.

Taking the fourth information including the information of the target radio bearer as an example, the target radio bearer may be, for example, a radio bearer for transmission of the first sidelink control information. In some implementations, the information of the target radio bearer may be used to indicate the target radio bearer. For example, the information of the target radio bearer may include an identifier of the target radio bearer.

Taking the fourth information including the information of the target data priority as an example, the target data priority may be, for example, a data priority of the first sidelink control information. In some implementations, the information of the target data priority may be used to indicate the data priority of the first sidelink control information. For example, the information of the target data priority may include a level of the target data priority. For another example, the information of the target data priority may include an identifier of the target data priority.

Taking the fourth information including the congestion degree of the first resource pool as an example, the first resource pool may be, for example, a resource pool for transmission of the first sidelink control information. In some implementations, the congestion degree of the first resource pool may be determined by a Channel Busy Ratio (CBR) of the first resource pool.

Taking the fourth information including the predefined information as an example, in some implementations, the predefined information may be used to indicate one or more available carriers, where the available carrier may be understood as a carrier available for transmission of the first sidelink control information. In other implementations, the predefined information may be used to indicate one or more available resource pools, where the available resource pool may be understood as a resource pool available for transmission of the first sidelink control information.

It is to be noted that the predefined information may be replaced with pre-configured information, and the pre-configured information may be pre-configured by the network device. Of course, the predefined information may be replaced with default information, that is to say, the available carrier and/or the available resource pool may be the default.

In some implementations, the second resource pool is determined based on a second association relationship. The second association relationship includes an association relationship between the second resource pool and the second carrier, and an association relationship between the second carrier and the fourth information. Of course, in an embodiment of the present disclosure, the second association relationship may also include an association relationship between the second resource pool and the fourth information. That is to say, the carrier associated with the fourth information of the first terminal device and a resource pool within the carrier may be determined by establishing a second association relationship. A carrier associated with the fourth information of the first terminal device is the second carrier, and a resource pool associated with the fourth information of the first terminal device is the second resource pool.

In some implementations, the second association relationship may include an association relationship between the second carrier and the fourth information, where the second carrier may be represented by indication information of the second carrier. That is to say, the carrier in the second association relationship may be represented as an index of the carrier, a serial number of the carrier, and the like. Taking the fourth information including the information of the first carrier as an example, the second association relationship may include an association relationship between information of the first carriers and indication information of carriers. Taking the fourth information including the information of the target QoS flow as an example, the second association relationship may include an association relationship between information of target QoS flows and indication information of carriers. Taking the fourth information including the information of the logical channel as an example, the second association relationship may include an association relationship between information of logical channels and indication information of carriers. Taking the fourth information including the information of the first resource pool as an example, the second association relationship may include an association relationship between information of the first resource pools and indication information of carriers. Taking the fourth information including the information of the target radio bearer as an example, the second association relationship may include an association relationship between information of target radio bearers and indication information of carriers. Taking the fourth information including the target data priority as an example, the second association relationship may include an association relationship between target data priorities and indication information of carriers. Taking the fourth information including the congestion degree of the first resource pool as an example, the second association relationship may include an association relationship between congestion degrees of the first resource pools and indication information of carriers.

It should be noted that the carrier(s) associated with the fourth information in the second association relationship may be one or more available carriers, that is to say, the fourth information in the second association relationship may be associated with a set of carriers (also referred to as “second set of carriers”), and the set of carriers may include one or more available carriers. That is to say, the second association relationship may include an association relationship between the second resource pool and the second set of carriers, and an association relationship between the second set of carriers and the fourth information, where the second set of carriers includes one or more carriers available for transmission of the second information.

Further, in the embodiment of the present disclosure, the available carrier(s) associated with the fourth information of the first terminal device may include a carrier carrying the second information (i.e., first sidelink data), that is, the second carrier.

In some implementations, the second association relationship may be defined by an AS of the first terminal device and/or the second terminal device. Of course, the second association relationship may be defined by another layer, and the embodiment of the present disclosure is not limited thereto.

It should be noted that the resource pool for transmission of the first sidelink data may be determined based on an association relationship between the fourth information and the first carrier, and the association relationship is established in a manner similar to the manner of establishing the second association relationship above, and the description thereof will not be repeated herein for the sake of brevity.

The manner for determining the second carrier is described above based on the third information and the fourth information respectively. In the embodiment of the present disclosure, the above-described manner for determining the second carrier may be used alone. Of course, in the embodiment of the present disclosure, the above-described manners for determining the second carrier may be used in combination with each other, for example, the third information and the fourth information may be used to establish an association relationship with the available carriers, and then the second carrier may be selected from the available carriers. The combination manner of the above two types of information may be pre-configured, predefined, configured by a network device, or determined through negotiation between the first terminal device and the second terminal device, and the embodiment of the present disclosure is not limited thereto.

In addition, in the embodiment of the present disclosure, the various association relationships (for example, the first association relationship, and the second association relationship) described above may be applied to a scenario of unicast communication between the first terminal device and the second terminal device, or to a scenario of multicast communication between the first terminal device and the second terminal device, or to a scenario of broadcast communication between the first terminal device and the second terminal device.

In some implementations, the first terminal device may further indicate the second carrier to the second terminal device in a dynamic indication manner. That is to say, the method further includes: the first terminal device sends first indication information to the second terminal device, the first indication information being used to indicate the second carrier. Herein, the first indication information may be carried in first-stage SCI and/or second-stage SCI; and of course, the first indication information may also be dedicated information that is independently transmitted, which is not limited in the embodiment of the present disclosure.

In some implementations, the first indication information includes one or more of: indication information of the second carrier; indication information of a second resource pool; indication information of a time domain resource for transmission of the second information; and indication information of a frequency domain resource for transmission of the second information.

The indication information of the second carrier may include, for example, an identifier of the second carrier, a sequence number of the second carrier, and the like. In some implementations, the indication information of the second carrier may include a CIF.

For the indication information of the second resource pool, the second resource pool is used for transmission of the second information (i.e., the first sidelink data). The indication information of the second resource pool is also referred to as a second resource pool indication.

The indication information of the time domain resource for transmission of the second information is also referred to as indication information of a time domain resource available for transmission of the second information. Herein, the indication information of the time domain resource is also referred to as an indication of the time domain resource, and for example, the indication information of the time domain resource may include an index of a symbol for transmission of the second information.

The indication information of the frequency domain resource for transmission of the second information is also referred to as indication information of a frequency domain resource available for transmission of the second information. Herein, the indication information of the frequency domain resource is also referred to as an indication of the frequency domain resource, and for example, the indication information of the frequency domain resource may include an index of a symbol for transmission of the second information.

It is to be noted that the above scheme for dynamically indicating the second carrier may also be applied to dynamically indicating the first carrier, and the specific indicating method is similar to the above scheme for indicating the second carrier. Detailed description will not be repeated here for the sake of brevity.

In some implementations, the first terminal device and the second terminal device may determine the first carrier and/or the second carrier through negotiation therebetween. Or in other words, the first carrier and/or the second carrier is determined based on negotiation between the first terminal device and the second terminal device.

In some implementations, the negotiation may be performed through capability interaction between the first terminal device and the second terminal device. The capability interaction may be indication of the capability information of the first terminal device by the first terminal device to the second terminal device. That is to say, the method further includes: the first terminal device sends the capability information of the first terminal device to the second terminal device, where the capability information of the first terminal device is used to indicate a carrier supported by the first terminal device and/or a number of carriers supported by the first terminal device.

The capability interaction may be indication of the capability information of the second terminal device by the second terminal device to the first terminal device. That is to say, the method further includes: the second terminal device sends the capability information of the second terminal device to the first terminal device, where the capability information of the second terminal device is used to indicate a carrier supported by the second terminal device and/or a number of carriers supported by the second terminal device.

Of course, in the embodiment of the present disclosure, the capability interaction may include indication of the capability information of the first terminal device by the first terminal device to the second terminal device, and indication of the capability information of the second terminal device by the second terminal device to the first terminal device. The embodiment of the present disclosure does not limit the sequence of transmission of the capability information of the first terminal device and the capability information of the second terminal device. For example, transmission of the capability information of the first terminal device may be performed before transmission of the capability information of the second terminal device. For another example, transmission of the capability information of the second terminal device may be performed before transmission of the capability information of the first terminal device. For another example, transmission of the capability information of the second terminal device may be performed simultaneously with transmission of the capability information of the first terminal device.

In some implementations, the first terminal device may determine the first carrier and/or the second carrier based on the capability information of the first terminal device and the capability information of the second terminal device. For example, when the capability information of the first terminal device indicates that carriers supported by the first terminal device are carriers 1 to 3, and the capability information of the second terminal device indicates that carriers supported by the second terminal device are carriers 2 to 3, then the first terminal device may select the carriers 2 to 3 as the first carrier and the second carrier. Of course, in the embodiment of the present disclosure, the second terminal device may determine the first carrier and/or the second carrier based on the capability information of the first terminal device and the capability information of the second terminal device. Alternatively, in the embodiment of the present disclosure, the second terminal device determines the second carrier based on the capability information of the first terminal device and the capability information of the second terminal device, and the first terminal device determines the first carrier based on the capability information of the first terminal device and the capability information of the second terminal device. Alternatively, the second terminal device determines the first carrier based on the capability information of the first terminal device and the capability information of the second terminal device, and the first terminal device determines the second carrier based on the capability information of the first terminal device and the capability information of the second terminal device.

In some implementations, the negotiation may be implemented by one or more signaling interactions between the first terminal device and the second terminal device. In order to facilitate understanding, description will be made below with reference to FIG. 10. For example, the signaling may include first configuration information, that is, the method further includes: the first terminal device sends the first configuration information to the second terminal device (see operation S1010), where the first configuration information is used to configure the first carrier and/or the second carrier for the second terminal device.

In some implementations, the first configuration information is used to configure a fourth set of carriers, where the fourth set of carriers includes one or more carriers available for transmission of the first information and/or the second information. Of course, in the embodiment of the present disclosure, the first configuration information may be used to directly configure the first carrier and/or the second carrier.

In the embodiment of the present disclosure, the first configuration information may be carried in PC5-RRC signaling; of course, in the embodiment of the present disclosure, the first configuration information may also be carried in dedicated signaling, and the embodiment of the present disclosure is not limited thereto.

For example, the signaling may include second configuration information, that is, the method further includes: the second terminal device sends the second configuration information to the first terminal device (see operation S1010), where the second configuration information is used to configure the first carrier and/or the second carrier for the first terminal device.

In the embodiment of the present disclosure, the second configuration information may be carried in PC5-RRC signaling; of course, in the embodiment of the present disclosure, the first configuration information may also be carried in dedicated signaling, and the embodiment of the present disclosure is not limited thereto.

In some implementations, the second configuration information is used to configure a fourth set of carriers, where the fourth set of carriers includes one or more carriers available for transmission of the first information and/or the second information. Of course, in the embodiment of the present disclosure, the second configuration information may be used to directly configure the first carrier and/or the second carrier.

For convenience of description, the terminal device that sends the first configuration information and/or the second configuration information is referred to as a “configuration terminal”, and the terminal device that receives the first configuration information and/or the second configuration information is referred to as a “non-configuration terminal”. That is to say, for the first configuration information, the configuration terminal is the first terminal device, and the non-configuration terminal is the second terminal device. For the second configuration information, the configuration terminal is the second terminal device, and the non-configuration terminal is the first terminal device.

In some scenarios, the non-configuration terminal may send a suggested carrier to the configuration terminal (see operation S1020) to improve the rationality of the configuration of the carrier by the configuration terminal. That is to say, before transmission of the first configuration information and/or the second configuration information is performed, the non-configuration terminal may send second indication information to the configuration terminal device, where the second indication information is used to indicate an available carrier (also referred to as a “candidate carrier”) suggested by the non-configuration terminal. The candidate carrier is used by the configuration terminal device to configure the first carrier and/or the second carrier.

In some scenarios, after the non-configuration terminal device receives the available carrier configured by the configuration terminal device, the available carrier may not be suitable, then the non-configuration terminal device may reject the available carrier. Of course, if the available carrier is suitable, the non-configuration terminal device may accept the available carrier.

If the non-configuration terminal device accepts the available carrier, the non-configuration terminal may send information indicating acceptance of the available carrier to the configuration terminal (see operation S1030). Of course, in the embodiment of the present disclosure, the non-configuration terminal may not send the information indicating acceptance of the available carrier to the configuration terminal, and accordingly, if the non-configuration terminal uses the available carrier within a preset time, it may be determined that the non-configuration terminal accepts the available carrier.

If the non-configuration terminal rejects the available carrier, the non-configuration terminal may send information indicating the rejection of the available carrier to the configuration terminal (see operation S1040). Of course, in the embodiment of the present disclosure, the non-configuration terminal may not send the information indicating rejection of the available carrier to the configuration terminal, and accordingly, if the non-configuration terminal does not use the available carrier after a preset time, it may be determined that the non-configuration terminal device rejects the available carrier.

In some scenarios, if the non-configuration terminal rejects the available carrier, the configuration terminal may send reconfiguration information to the non-configuration terminal (see operation S1050), where the reconfiguration information is used to reconfigure the first carrier and/or the second carrier for the non-configuration terminal.

In some implementations, the reconfiguration process may be considered to have failed if a preset condition is met. The preset condition may be related to a number of times that the configuration terminal configures the first carrier and/or the second carrier for the non-configuration terminal, and/or the preset condition may be related to a length of time taken by the configuration terminal to configure the first carrier and/or the second carrier for the non-configuration terminal.

For example, if the preset condition is related to the number of times that the configuration terminal configures the first carrier and/or the second carrier for the non-configuration terminal, the preset condition may include: the number of times that the configuration terminal configures the first carrier and/or the second carrier for the non-configuration terminal is greater than a threshold value.

For another example, if the preset condition is related to the length of time taken by the configuration terminal to configure the first carrier and/or the second carrier for the non-configuration terminal, the preset condition may include: the length of time taken by the configuration terminal to configure the first carrier and/or the second carrier for the non-configuration terminal is longer than a threshold value.

It is to be noted that in the embodiment of the present disclosure, the reason why the non-configuration terminal rejects the available carrier is not limited. For example, assuming that the non-configuration terminal is a terminal device 1, and the configuration terminals include a terminal device 2 and a terminal device 3, then the terminal device 2 configures the terminal device 1 to send first sidelink data on the carrier 2, and the terminal device 3 configures the terminal device 1 to send first sidelink data on the carrier 3. At this time, the terminal device 1 needs to send first sidelink data on the carrier 2 and the carrier 3 respectively, resulting in a large power consumption of the terminal device 1, then the terminal device 1 may reject the configuration by the terminal device 3.

Further, the first configuration information and/or the second configuration information may be determined based on the candidate carrier(s) indicated by the non-configuration terminal. In the embodiment of the present disclosure, the first configuration information and/or the second configuration information may be independently determined by the configuration terminal, and the embodiment of the present disclosure is not limited thereto.

In some implementations, any of the configuration processes described above may be used in conjunction with dynamic activation. That is to say, after the available carrier configured by the first configuration information and/or the second configuration information is configured to the non-configuration terminal, the configuration terminal may send third instruction information to the non-configuration terminal to indicate whether to activate the configured available carrier. In other words, the third indication information is used to indicate whether transmission of the second information is allowed to be performed through the second carrier.

For example, the terminal device 1 configures the set A of carriers for the terminal device 2, at this time, the set A of carriers includes one or more available carriers associated with the second information, and then the terminal device 1 may send the indication information 3 to the terminal device 2 to indicate a carrier in the set A of carriers, which can be used for transmission of the second information.

In the embodiment of the present disclosure, the manner by which the third indication information is carried is not limited. For example, the third indication information may be carried in an MAC CE. For another example, the third indication information may be carried in SCI.

In some implementations, whether transmission of the second information is performed through the second carrier is determined based on one or more of: whether a carrier available for transmission of the second information exists; a QoS parameter associated with the first information; a quality of communication between the first terminal device and the second terminal device; and a resource congestion condition of resources available for transmission of the second information.

If whether transmission of the second information is performed through the second carrier is determined based on whether the carrier available for transmission of the second information exists, in some implementations, if the carrier available for transmission of the second information exists, the transmission of the second information may be performed through the second carrier. In other implementations, if the carrier available for transmission of the second information does not exist, the transmission of the second information is not performed through the second carrier.

For example, if there is only a second carrier (i.e. cross-carrier scheduling resource), transmission of the second information may be performed through the second carrier (i.e. using cross-carrier scheduling). For another example, if the current resource pool is a PSCCH-only resource pool, the transmission of the second information may be performed through the second carrier (i.e., using cross-carrier scheduling). For another example, if the resource pool on the current carrier is a PSCCH-only resource pool, the transmission of the second information may be performed through the second carrier (i.e., using cross-carrier scheduling).

For example, if there is not a second carrier (i.e. cross-carrier scheduling resource), transmission of the second information may not be performed through the second carrier (i.e. using cross-carrier scheduling). For another example, if the current resource pool is not a PSCCH-only resource pool, the transmission of the second information may not be performed through the second carrier (i.e., using cross-carrier scheduling). For another example, if the resource pool on the current carrier is not a PSCCH-only carrier, the transmission of the second information may not be performed through the second carrier (i.e., using cross-carrier scheduling).

If whether transmission of the second information is performed through the second carrier is determined based on the QoS parameter associated with the first information, in some implementations, if the QoS parameter associated with the first information has higher requirement, the transmission of the second information may be performed through the second carrier. In other implementations, if the QoS parameter associated with the first information has lower requirement, the transmission of the second information is not performed through the second carrier.

Alternatively, in other implementations, if the QoS parameter associated with the first information has lower requirement, the transmission of the second information may be performed through the second carrier. In other implementations, if the QoS parameter associated with the first information has higher requirement, the transmission of the second information is not performed through the second carrier.

For example, the QoS parameter includes a transmission delay, and if the transmission delay associated with the first information is less than a threshold value, the transmission of the second information may be performed through the second carrier. Conversely, if the transmission delay associated with the first information is greater than the threshold value, the transmission of the second information is not performed through the second carrier.

For another example, the QoS parameter includes a Packet Error Rate (PER), and if the PER associated with the first information is greater than a threshold value, the transmission of the second information may be performed through the second carrier. Conversely, if the PER associated with the first information is less than the threshold value, the transmission of the second information is not performed through the second carrier.

If whether transmission of the second information is performed through the second carrier is determined based on the communication quality, in some implementations, if the communication quality is higher, the transmission of the second information may be performed through the second carrier. In other implementations, if the communication quality is lower, the transmission of the second information is not performed through the second carrier. Alternatively, in some implementations, if the communication quality is higher, the transmission of the second information may not be performed through the second carrier. In other implementations, if the communication quality is lower, the transmission of the second information is performed through the second carrier.

For example, the communication quality is determined based on a packet loss rate, and if the packet loss rate is lower than a threshold value, the transmission of the second information may be performed through the second carrier. Conversely, if the packet loss rate is higher than the threshold value, the transmission of the second information is not performed through the second carrier.

For example, the communication quality is determined based on a receiving status of the first sidelink data, and if the receiving status of the first sidelink data indicates activation once feedback information has not been received for x consecutive times, and x is higher than a threshold value, then the transmission of the second information may be performed through the second carrier. Conversely, if the receiving status of the first sidelink data indicates activation once feedback information has not been received for x consecutive times, and x is lower than the threshold value, then the transmission of the second information is not performed through the second carrier, where x is a positive integer.

If whether transmission of the second information is performed through the second carrier is determined based on the resource congestion condition, in some implementations, if the resource congestion condition is severe (e.g., the CBR is above a threshold value), the transmission of the second information may not be performed through the second carrier. In other implementations, if the resource congestion condition is not severe (e.g., the CBR is below the threshold value), the transmission of the second information is performed through the second carrier.

Of course, in the embodiment of the present disclosure, whether transmission of the second information is performed through the second carrier can further be determined by other means. In some implementations, whether transmission of the second information is performed through the second carrier may be determined based on a preset rule.

In other implementations, whether transmission of the second information is performed through the second carrier may be determined based on an upper layer (for example, NAS) indication. For example, whether transmission of the second information is performed through the second carrier may be determined based on third information, where for description of the third information, reference can be made to the above, which will not be repeated for the sake of brevity. For another example, whether transmission of the second information is performed through the second carrier may be determined based on a first association relationship associated with the third information, where for description of the first association relationship, reference can be made to the above, which will not be repeated for the sake of brevity.

In other implementations, whether transmission of the second information is performed through the second carrier may be determined based on an AS configuration. Activation of the AS configuration may be configured, for example, per bearer; or activation of the AS configuration may be configured, for example, per LCH; or activation of the AS configuration may be configured, for example, per link; or activation of the AS configuration may be configured, for example, per sidelink grant; or activation of the AS configuration may be configured, for example, per CG. The AS configuration may be configured by a network device or another terminal device.

In other implementations, whether transmission of the second information is performed through the second carrier may be determined based on dynamic indication (or indication information). Herein, the indication information may be configured by a network device or another terminal device. Further, the indication information may be carried in one or more of the following: MAC CE, SCI, and DCI.

The determination of whether transmission of the second information is performed through the second carrier may be performed by the first terminal device or the second terminal device. Of course, in the embodiment of the present disclosure, the determination of whether transmission of the second information is performed through the second carrier may also be determined by the network device, and the embodiment of the present disclosure is not limited thereto.

At present, after the cross-carrier scheduling scheme of the embodiment of the present disclosure is introduced, how the second timer associated with the SL DRX mechanism works is an urgent problem to be solved. Therefore, in an embodiment of the present disclosure, it is proposed that the second timer is associated with the first carrier and/or the second timer is associated with the second carrier, where the second timer for the SL DRX is associated with the transmission of the second information.

In some implementations, the second timer is used to determine inactivation time of the second terminal device, and the second timer may be, for example, an “inactivity timer”. In other implementations, the second timer is used to determine round-trip time for transmission of the first information, and the second timer may be, for example, an “RTT timer”.

For example, the inactivity timer and/or the RTT timer may be started according to only transmissions on the scheduling carrier (first carrier), a retransmission timer may be started after the RTT timer expires, and data transmissions on the scheduling and scheduled carriers (first carrier and second carrier) are monitored during operation of the inactivity timer and the retransmission timer.

For another example, the inactive timer may be turned on for transmissions on both scheduling or scheduled carriers (first carrier and second carrier), a retransmission timer may be turned on after the RTT timer expires, and data transmissions on the scheduling and scheduled carriers may be monitored during operation of the inactivity timer and the retransmission timer.

For another example, the inactivity timer and the retransmission timer may be turned on for transmissions on both scheduling or scheduled carriers (first carrier and second carrier), and data transmissions on the scheduling and scheduled carriers may be monitored during operation of the inactivity timer and retransmission timer.

At present, when transmission of the third sidelink data and the fourth sidelink data is performed between the first terminal device and the second terminal device, the transmission of the third sidelink data and the fourth sidelink data needs to be performed through the same carrier, which leads to poor flexibility of transmission of the third sidelink data and the fourth sidelink data. Herein, the fourth sidelink data is retransmission data of the third sidelink data. Therefore, in view of the problem above, an embodiment of the present disclosure provides a method for sidellink communication. According to the method, transmission of the third sidelink data and the fourth sidelink data can be performed through different carriers (for example, the first carrier and the second carrier), which is helpful to improve the flexibility of transmission of the third sidelink data and the fourth sidelink data. In order to facilitate understanding, the method for sidelink communication according to an embodiment of the present disclosure will be described below based on a third embodiment.

In a third embodiment, it is assumed that the first information includes first sidelink data, and the second information includes second sidelink data, where the second sidelink data is retransmission data of the first sidelink data.

In some implementations, the third sidelink data may be initial transmission sidelink data, or the third sidelink data is retransmission sidelink data.

As described above, the transmission of the third sidelink data and the fourth sidelink data may be performed through different carriers, thus how to determine the second carrier used for transmission of the fourth sidelink data is an urgent problem to be solved. Therefore, in view of this problem, it is proposed in the embodiment of the present disclosure that the second carrier may be determined based on some information (hereinafter, also referred to as “third information”) shared by the first terminal device and the second terminal device.

That is to say, the second carrier may be determined based on third information, where the third information includes one or more of: information of a target service type, information of a target service, information of a target application type, information of a target application, Layer 2 information, a transmission configuration, information of a target Quality of Service (QoS) flow, and a data transmission type.

Taking the third information including information of a target service type as an example, the target service type may be, for example, a service type of a service to which the third sidelink data belongs. Herein, the target service type may include, for example, a rate-prioritized service type, a reliability-prioritized service type, and the like, and the embodiment of the present disclosure is not limited thereto.

In some implementations, the information of the target service type may be used to indicate the target service type, for example, the information of the target service type may be an index of the target service type.

Taking the third information including information of a target service as an example, the target service may be, for example, a service to which the third sidelink data belongs. In some implementations, the information of the target service is used to indicate the target service, for example, the information of the target service may be an index of the target service.

Taking the third information including information of a target application type as an example, the target application type may be, for example, an application type of an application to which the third sidelink data belongs. In some implementations, the information of the target application type may be used to indicate the target application type, for example, the information of the target application type may be an index of the target application type.

Taking the third information including information of a target application as an example, the target application may be, for example, an application type of an application to which the third sidelink data belongs. In some implementations, the information of the target application is used to indicate the target application, for example, the information of the target application may be an index of the target application.

Taking the third information including Layer 2 information as an example, the Layer 2 information may be, for example, associated with the third sidelink data, and in some implementations, a communication device that performs transmission of the third sidelink data through the Layer 2, for example, the Layer 2 information may include a Layer 2 index.

Taking the third information including information of a transmission configuration (Tx profile) as an example, the information of the transmission configuration may be associated with the third sidelink data, for example, and in some implementations, the information of the transmission configuration may be used to indicate a transmission configuration of the third sidelink data. For example, the transmission configuration may include indication information of the transmission configuration. For another example, the transmission configuration may include a transmission configuration parameter of the third sidelink data.

Taking the third information including information of a target QoS flow as an example, the target QoS flow may be, for example, a QoS flow in which the third sidelink data is located, and in some implementations, the information of the target QoS flow may be used to indicate the target QoS flow. For example, the information of the target QoS flow may include an identifier of the target QoS flow.

Taking the third information including information of a data transmission type as an example, the data transmission type may be, for example, a data transmission type of the third sidelink data, where the data transmission type may include one or more of unicast, multicast, and broadcast. In some implementations, the information of the data transmission type may be used to indicate the data transmission type. For example, the information of the data transmission type may include an identifier of the data transmission type.

In some implementations, the second carrier is determined based on a first association relationship between the second carrier and the third information. That is to say, the carrier associated with the third information of the first terminal device may be determined by establishing an association relationship between carriers and the third information, and a carrier associated with the third information of the first terminal device is the second carrier.

In some implementations, the first association relationship may be an association relationship between third information and carrier indication information, where the carrier indication information may be an index of a carrier, a sequence number of a carrier, or the like. Taking the third information including the information of the target service type as an example, the first association relationship may include an association relationship between information of target service types and indication information of carriers. Taking the third information including the information of the target service as an example, the first association relationship may include an association relationship between information of target services and indication information of carriers. Taking the third information including the information of the target application type as an example, the first association relationship may include an association relationship between information of target application types and indication information of carriers. Taking the third information including the Layer 2 information as an example, the first association relationship may include an association relationship between Layer 2 information and indication information of carriers. Taking the third information including the transmission configuration as an example, the first association relationship may include an association relationship between transmission configurations and indication information of carriers. Taking the third information including the information of the target QoS flow as an example, the first association relationship may include an association relationship between information of target QoS flows and indication information of carriers. Taking the third information including the data transmission type as an example, the first association relationship may include an association relationship between information of data transmission types and indication information of carriers.

It should be noted that the carrier(s) associated with the third information in the first association relationship may be one or more available carriers, that is to say, the third information in the first association relationship may be associated with a set of carriers, and the set of carriers may include one or more available carriers. For example, the second carrier belongs to a first set of carriers, and the first association relationship includes an association relationship between the first set of carriers and the third information, and the first set of carriers includes one or more carriers available for transmission of the fourth sidelink data.

Further, in the embodiment of the present disclosure, the available carrier(s) associated with the third information of the first terminal device may include a carrier carrying the fourth sidelink data, that is, the second carrier.

In some implementations, the first association relationship may be defined by an upper layer of the first terminal device and/or the second terminal device, or the first association relationship may be applied to an upper layer of the first terminal device and/or the second terminal device. For example, the first association relationship may be defined by the NAS. For another example, the first association relationship may be defined by a V2X layer. For another example, the first association relationship may be defined by a proximity-based services (ProSe) layer.

It should be noted that the first carrier may be determined based on an association relationship between the third information and the first carrier, and the association relationship is established in a manner similar to the manner of establishing the first association relationship above, and the description thereof will not be repeated herein for the sake of brevity.

In some scenarios, after the available carrier(s) of the fourth sidelink data is/are determined, it is also necessary to determine a sidelink resource for transmission of the fourth sidelink data (or a time-frequency resource for transmission of the fourth sidelink data) and/or the second carrier. In some implementations, the time-frequency resource for transmission of the fourth sidelink data belongs to a second resource pool corresponding to the second carrier, and the second carrier and/or the second resource pool is determined based on the fourth information.

In some implementations, the fourth information includes one or more of: information of the first carrier, the information of the target QoS flow, information of a logical channel, information of a first resource pool, information of a target radio bearer, a target data priority, a congestion degree of the first resource pool, and predefined information.

Taking the fourth information including the information of the first carrier as an example, the first carrier is a carrier for transmission of the third sidelink data, thus the first carrier may also be referred to as a “data transmission carrier”. In some implementations, the information of the first carrier may be used to indicate the first carrier, for example, the information of the first carrier may be a sequence number of the first carrier.

Taking the fourth information including the information of the logical channel as an example, the logical channel may be, for example, a logical channel on which the third sidelink data is located. In some implementations, the information of the logical channel may be used to indicate the logical channel. For example, the information of the logical channel may include an identifier of the logical channel.

Taking the fourth information including the information of the first resource pool as an example, the first resource pool may be, for example, a resource pool for transmission of the third sidelink data. In some implementations, the information of the first resource pool may be used to indicate the first resource pool. For example, the information of the first resource pool may include an identifier of the first resource pool.

Taking the fourth information including the information of the target radio bearer as an example, the target radio bearer may be, for example, a radio bearer for transmission of the third sidelink data. In some implementations, the information of the target radio bearer may be used to indicate the target radio bearer. For example, the information of the target radio bearer may include an identifier of the target radio bearer.

Taking the fourth information including the information of the target data priority as an example, the target data priority may be, for example, a data priority of the third sidelink data. In some implementations, the information of the target data priority may be used to indicate the data priority of the third sidelink data. For example, the information of the target data priority may include a level of the target data priority. For another example, the information of the target data priority may include an identifier of the target data priority.

Taking the fourth information including the congestion degree of the first resource pool as an example, the first resource pool may be, for example, a resource pool for transmission of the third sidelink data. In some implementations, the congestion degree of the first resource pool may be determined by a Channel Busy Ratio (CBR) of the first resource pool.

Taking the fourth information including the predefined information as an example, in some implementations, the predefined information may be used to indicate one or more available carriers, where the available carrier may be understood as a carrier available for transmission of the third sidelink data. In other implementations, the predefined information may be used to indicate one or more available resource pools, where the available resource pool may be understood as a resource pool available for transmission of the third sidelink data.

It is to be noted that the predefined information may be replaced with pre-configured information, and the pre-configured information may be pre-configured by the network device. Of course, the predefined information may be replaced with default information, that is to say, the available carrier and/or the available resource pool may be the default.

In some implementations, the second resource pool is determined based on a second association relationship. The second association relationship includes an association relationship between the second resource pool and the second carrier, and an association relationship between the second carrier and the fourth information. Of course, in an embodiment of the present disclosure, the second association relationship may also include an association relationship between the second resource pool and the fourth information. That is to say, the carrier associated with the fourth information of the first terminal device and a resource pool within the carrier may be determined by establishing a second association relationship. A carrier associated with the fourth information of the first terminal device is the second carrier, and a resource pool associated with the fourth information of the first terminal device is the second resource pool.

In some implementations, the second association relationship may include an association relationship between the second carrier and the fourth information, where the second carrier may be represented by indication information of the second carrier. That is to say, the carrier in the second association relationship may be represented as an index of the carrier, a serial number of the carrier, and the like. Taking the fourth information including the information of the first carrier as an example, the second association relationship may include an association relationship between information of the first carriers and indication information of carriers. Taking the fourth information including the information of the target QoS flow as an example, the second association relationship may include an association relationship between information of target QoS flows and indication information of carriers. Taking the fourth information including the information of the logical channel as an example, the second association relationship may include an association relationship between information of logical channels and indication information of carriers. Taking the fourth information including the information of the first resource pool as an example, the second association relationship may include an association relationship between information of the first resource pools and indication information of carriers. Taking the fourth information including the information of the target radio bearer as an example, the second association relationship may include an association relationship between information of target radio bearers and indication information of carriers. Taking the fourth information including the target data priority as an example, the second association relationship may include an association relationship between target data priorities and indication information of carriers. Taking the fourth information including the congestion degree of the first resource pool as an example, the second association relationship may include an association relationship between congestion degrees of the first resource pools and indication information of carriers.

It should be noted that the carrier(s) associated with the fourth information in the second association relationship may be one or more available carriers, that is to say, the fourth information in the second association relationship may be associated with a set of carriers (also referred to as “second set of carriers”), and the set of carriers may include one or more available carriers. That is to say, the second association relationship may include an association relationship between the second resource pool and the second set of carriers, and an association relationship between the second set of carriers and the fourth information, where the second set of carriers includes one or more carriers available for transmission of the fourth sidelink data.

Further, in the embodiment of the present disclosure, the available carrier(s) associated with the fourth information of the first terminal device may include a carrier carrying the fourth sidelink data, that is, the second carrier.

In some implementations, the second association relationship may be defined by an Access Stratum (AS) of the first terminal device and/or the second terminal device. Of course, in the embodiment of the present disclosure, the second association relationship may be defined by another layer, and the embodiment of the present disclosure is not limited thereto.

It should be noted that the resource pool for transmission of the fourth sidelink data may be determined based on an association relationship between the fourth information and the first carrier, and the association relationship is established in a manner similar to the manner of establishing the second association relationship above, and the description thereof will not be repeated herein for the sake of brevity.

The manner for determining the second carrier is described above based on the third information and the fourth information respectively. In the embodiment of the present disclosure, the above-described manner for determining the second carrier may be used alone. Of course, in the embodiment of the present disclosure, the above-described manners for determining the second carrier may be used in combination with each other, for example, the third information and the fourth information may be used to establish an association relationship with the available carriers, and then the second carrier may be selected from the available carriers. For another example, the fourth information and the fifth information may be used to establish an association relationship with the available carriers, and then the second carrier may be selected from the available carriers. For another example, the third information and the fifth information may be used to establish an association relationship with the available carriers, and then the second carrier may be selected from the available carriers. The combination manner of the above three types of information may be pre-configured, predefined, configured by a network device, or determined through negotiation between the first terminal device and the second terminal device, and the embodiment of the present disclosure is not limited thereto.

In addition, in the embodiment of the present disclosure, the various association relationships (for example, the first association relationship, the second association relationship, and the third association relationship) described above may be applied to a scenario of unicast communication between the first terminal device and the second terminal device, or to a scenario of multicast communication between the first terminal device and the second terminal device, or to a scenario of broadcast communication between the first terminal device and the second terminal device.

In some implementations, the first terminal device may further indicate the second carrier to the second terminal device in a dynamic indication manner. That is to say, the method further includes: the first terminal device sends first indication information to the second terminal device, the first indication information being used to indicate the second carrier. Herein, the first indication information may be carried in first-stage SCI and/or second-stage SCI; and of course, the first indication information may also be dedicated information that is independently transmitted, which is not limited in the embodiment of the present disclosure.

In some implementations, the first indication information includes one or more of: indication information of the second carrier; indication information of a second resource pool; indication information of a time domain resource for transmission of fourth sidelink data; and indication information of a frequency domain resource for transmission of the four sidelink data.

The indication information of the second carrier may include, for example, an identifier of the second carrier, a sequence number of the second carrier, and the like. In some implementations, the indication information of the second carrier may include a carrier indication CIF.

For the indication information of the second resource pool, the second resource pool is used for transmission of the fourth sidelink data. The indication information of the second resource pool is also referred to as a second resource pool indication.

The indication information of the time domain resource for transmission of the fourth sidelink data is also referred to as indication information of a time domain resource available for transmission of the fourth sidelink data. Herein, the indication information of the time domain resource is also referred to as an indication of the time domain resource, and for example, the indication information of the time domain resource may include an index of a symbol for transmission of the fourth sidelink data.

The indication information of the frequency domain resource for transmission of the fourth sidelink data is also referred to as indication information of a frequency domain resource available for transmission of the fourth sidelink data. Herein, the indication information of the frequency domain resource is also referred to as an indication of the frequency domain resource, and for example, the indication information of the frequency domain resource may include an index of a symbol for transmission of the fourth sidelink data.

It is to be noted that the above scheme for dynamically indicating the second carrier may also be applied to dynamically indicating the first carrier, and the specific indicating method is similar to the above scheme for indicating the second carrier. Detailed description will not be repeated here for the sake of brevity.

In some implementations, the first terminal device and the second terminal device may determine the first carrier and/or the second carrier through negotiation therebetween. Or in other words, the first carrier and/or the second carrier is determined based on negotiation between the first terminal device and the second terminal device.

In some implementations, the negotiation may be performed through capability interaction between the first terminal device and the second terminal device. The capability interaction may be indication of the capability information of the first terminal device by the first terminal device to the second terminal device. That is to say, the method further includes: the first terminal device sends the capability information of the first terminal device to the second terminal device, where the capability information of the first terminal device is used to indicate a carrier supported by the first terminal device and/or a number of carriers supported by the first terminal device.

The capability interaction may be indication of the capability information of the second terminal device by the second terminal device to the first terminal device. That is to say, the method further includes: the second terminal device sends the capability information of the second terminal device to the first terminal device, where the capability information of the second terminal device is used to indicate a carrier supported by the second terminal device and/or a number of carriers supported by the second terminal device.

Of course, in the embodiment of the present disclosure, the capability interaction may include indication of the capability information of the first terminal device by the first terminal device to the second terminal device, and indication of the capability information of the second terminal device by the second terminal device to the first terminal device. The embodiment of the present disclosure does not limit the sequence of transmission of the capability information of the first terminal device and the capability information of the second terminal device. For example, transmission of the capability information of the first terminal device may be performed before transmission of the capability information of the second terminal device. For another example, transmission of the capability information of the second terminal device may be performed before transmission of the capability information of the first terminal device. For another example, transmission of the capability information of the second terminal device may be performed simultaneously with transmission of the capability information of the first terminal device.

In some implementations, the first terminal device may determine the first carrier and/or the second carrier based on the capability information of the first terminal device and the capability information of the second terminal device. For example, when the capability information of the first terminal device indicates that carriers supported by the first terminal device are carriers 1 to 3, and the capability information of the second terminal device indicates that carriers supported by the second terminal device are carriers 2 to 3, then the first terminal device may select the carriers 2 to 3 as the first carrier and the second carrier. Of course, in the embodiment of the present disclosure, the second terminal device may determine the first carrier and/or the second carrier based on the capability information of the first terminal device and the capability information of the second terminal device. Alternatively, in the embodiment of the present disclosure, the second terminal device determines the second carrier based on the capability information of the first terminal device and the capability information of the second terminal device, and the first terminal device determines the first carrier based on the capability information of the first terminal device and the capability information of the second terminal device. Alternatively, the second terminal device determines the first carrier based on the capability information of the first terminal device and the capability information of the second terminal device, and the first terminal device determines the second carrier based on the capability information of the first terminal device and the capability information of the second terminal device.

In some implementations, the negotiation may be implemented by one or more signaling interactions between the first terminal device and the second terminal device. In order to facilitate understanding, description will be made below with reference to FIG. 10. For example, the signaling may include first configuration information, that is, the method further includes: the first terminal device sends the first configuration information to the second terminal device (see operation S1010), where the first configuration information is used to configure the first carrier and/or the second carrier for the second terminal device.

In some implementations, the first configuration information is used to configure a fourth set of carriers, where the fourth set of carriers includes one or more carriers available for transmission of the third sidelink data and/or the fourth sidelink data. Of course, in the embodiment of the present disclosure, the first configuration information may be used to directly configure the first carrier and/or the second carrier.

In the embodiment of the present disclosure, the first configuration information may be carried in PC5-RRC signaling; of course, in the embodiment of the present disclosure, the first configuration information may also be carried in dedicated signaling, and the embodiment of the present disclosure is not limited thereto.

For example, the signaling may include second configuration information, that is, the method further includes: the second terminal device sends the second configuration information to the first terminal device (see operation S1010), where the second configuration information is used to configure the first carrier and/or the second carrier for the first terminal device.

In the embodiment of the present disclosure, the second configuration information may be carried in PC5-RRC signaling; of course, in the embodiment of the present disclosure, the first configuration information may also be carried in dedicated signaling, and the embodiment of the present disclosure is not limited thereto.

In some implementations, the second configuration information is used to configure a fourth set of carriers, where the fourth set of carriers includes one or more carriers available for transmission of the third sidelink data and/or the fourth sidelink data. Of course, in the embodiment of the present disclosure, the second configuration information may be used to directly configure the first carrier and/or the second carrier.

For convenience of description, the terminal device that sends the first configuration information and/or the second configuration information is referred to as a “configuration terminal”, and the terminal device that receives the first configuration information and/or the second configuration information is referred to as a “non-configuration terminal”. That is to say, for the first configuration information, the configuration terminal is the first terminal device, and the non-configuration terminal is the second terminal device. For the second configuration information, the configuration terminal is the second terminal device, and the non-configuration terminal is the first terminal device.

In some scenarios, the non-configuration terminal may send a suggested carrier to the configuration terminal (see operation S1020) to improve the rationality of the configuration of the carrier by the configuration terminal. That is to say, before transmission of the first configuration information and/or the second configuration information is performed, the non-configuration terminal may send second indication information to the configuration terminal device, where the second indication information is used to indicate an available carrier (also referred to as a “candidate carrier”) suggested by the non-configuration terminal. The candidate carrier is used by the configuration terminal device to configure the first carrier and/or the second carrier.

In some scenarios, after the non-configuration terminal device receives the available carrier configured by the configuration terminal device, the available carrier may not be suitable, then the non-configuration terminal device may reject the available carrier. Of course, if the available carrier is suitable, the non-configuration terminal device may accept the available carrier.

If the non-configuration terminal device accepts the available carrier, the non-configuration terminal may send information indicating acceptance of the available carrier to the configuration terminal (see operation S1030). Of course, in the embodiment of the present disclosure, the non-configuration terminal may not send the information indicating acceptance of the available carrier to the configuration terminal, and accordingly, if the non-configuration terminal uses the available carrier within a preset time, it may be determined that the non-configuration terminal accepts the available carrier.

If the non-configuration terminal rejects the available carrier, the non-configuration terminal may send information indicating the rejection of the available carrier to the configuration terminal (see operation S1040). Of course, in the embodiment of the present disclosure, the non-configuration terminal may not send the information indicating rejection of the available carrier to the configuration terminal, and accordingly, if the non-configuration terminal does not use the available carrier after a preset time, it may be determined that the non-configuration terminal device rejects the available carrier.

In some scenarios, if the non-configuration terminal rejects the available carrier, the configuration terminal may send reconfiguration information to the non-configuration terminal (see operation S1050), where the reconfiguration information is used to reconfigure the first carrier and/or the second carrier for the non-configuration terminal.

In some implementations, the reconfiguration process may be considered to have failed if a preset condition is met. The preset condition may be related to a number of times that the configuration terminal configures the first carrier and/or the second carrier for the non-configuration terminal, and/or the preset condition may be related to a length of time taken by the configuration terminal to configure the first carrier and/or the second carrier for the non-configuration terminal.

For example, if the preset condition is related to the number of times that the configuration terminal configures the first carrier and/or the second carrier for the non-configuration terminal, the preset condition may include: the number of times that the configuration terminal configures the first carrier and/or the second carrier for the non-configuration terminal is greater than a threshold value.

For another example, if the preset condition is related to the length of time taken by the configuration terminal to configure the first carrier and/or the second carrier for the non-configuration terminal, the preset condition may include: the length of time taken by the configuration terminal to configure the first carrier and/or the second carrier for the non-configuration terminal is longer than a threshold value.

It is to be noted that in the embodiment of the present disclosure, the reason why the non-configuration terminal rejects the available carrier is not limited. For example, assuming that the non-configuration terminal is a terminal device 1, and the configuration terminals include a terminal device 2 and a terminal device 3, then the terminal device 2 configures the terminal device 1 to receive the fourth sidelink data on the carrier 2, and the terminal device 3 configures the terminal device 1 to receive the fourth sidelink data on the carrier 3. At this time, the terminal device 1 needs to receive the fourth sidelink data on the carrier 2 and the carrier 3 respectively, resulting in a large power consumption of the terminal device 1, then the terminal device 1 may reject the configuration by the terminal device 3.

Further, the first configuration information and/or the second configuration information may be determined based on the candidate carrier(s) indicated by the non-configuration terminal. In the embodiment of the present disclosure, the first configuration information and/or the second configuration information may be independently determined by the configuration terminal, and the embodiment of the present disclosure is not limited thereto.

In some implementations, any of the configuration processes described above may be used in conjunction with dynamic activation. That is to say, after the available carrier configured by the first configuration information and/or the second configuration information is configured to the non-configuration terminal, the configuration terminal may send third instruction information to the non-configuration terminal to indicate whether to activate the configured available carrier. In other words, the third indication information is used to indicate whether transmission of the fourth sidelink data is allowed to be performed through the second carrier.

For example, the terminal device 1 configures the set A of carriers for the terminal device 2, at this time, the set A of carriers includes one or more available carriers associated with the fourth sidelink data, and then the terminal device 1 may send the indication information 3 to the terminal device 2 to indicate a carrier in the set A of carriers, which can be used for transmission of the fourth sidelink data.

In the embodiment of the present disclosure, the manner by which the third indication information is carried is not limited. For example, the third indication information may be carried in an MAC CE. For another example, the third indication information may be carried in SCI.

In some implementations, whether transmission of the fourth sidelink data is performed through the second carrier is determined based on one or more of: whether a carrier available for transmission of the fourth sidelink data exists; a QoS parameter associated with the fourth sidelink data; a quality of communication between the first terminal device and the second terminal device; and a resource congestion condition of resources available for transmission of the fourth sidelink data.

If transmission of the fourth sidelink data is performed through the second carrier is determined based on whether the carrier available for transmission of the fourth sidelink data exists, in some implementations, if the carrier available for transmission of the fourth sidelink data exists, transmission of the fourth sidelink data may be performed through the second carrier. In other implementations, if the carrier available for transmission of the fourth sidelink data does not exist, transmission of the fourth sidelink data is not performed through the second carrier.

For example, if there is only a second carrier (i.e. cross-carrier retransmission resource), the transmission of the fourth sidelink data may be performed through the second carrier (i.e. using cross-carrier retransmission). For another example, if there is no second carrier (i.e., cross-carrier retransmission resource), the transmission of the fourth sidelink data may not be performed through the second carrier (i.e., using cross-carrier retransmission).

If whether transmission of the fourth sidelink data is performed through the second carrier is determined based on the QoS parameter associated with the third sidelink data, in some implementations, if the QoS parameter associated with the third sidelink data has higher requirement, the transmission of the fourth sidelink data may be performed through the second carrier. In other implementations, if the QoS parameter associated with the third sidelink data has lower requirement, the transmission of the fourth sidelink data is not performed through the second carrier.

Alternatively, in other implementations, if the QoS parameter associated with the third sidelink data has lower requirement, the transmission of the fourth sidelink data may be performed through the second carrier. In other implementations, if the QoS parameter associated with the third sidelink data has higher requirement, the transmission of the fourth sidelink data is not performed through the second carrier.

For example, the QoS parameter includes a transmission delay, and if the transmission delay associated with the third sidelink data is less than a threshold value, the transmission of the fourth sidelink may be performed through the second carrier. Conversely, if the transmission delay associated with the third sidelink data is greater than the threshold value, the transmission of the fourth sidelink data is not performed through the second carrier.

For another example, the QoS parameter includes a Packet Error Rate (PER), and if the PER associated with the third sidelink data is greater than a threshold value, the transmission of the fourth sidelink data may be performed through the second carrier. Conversely, if the PER associated with the third sidelink data is less than the threshold value, the transmission of the fourth sidelink data is not performed through the second carrier.

If whether transmission of the fourth sidelink data is performed through the second carrier is determined based on the communication quality, in some implementations, if the communication quality is higher, the transmission of the fourth sidelink data may be performed through the second carrier. In other implementations, if the communication quality is lower, the transmission of the fourth sidelink data is not performed through the second carrier. Alternatively, in some implementations, if the communication quality is higher, the transmission of the fourth sidelink data may not be performed through the second carrier. In other implementations, if the communication quality is lower, the transmission of the fourth sidelink data is performed through the second carrier.

For example, the communication quality is determined based on a packet loss rate, and if the packet loss rate is lower than a threshold value, the transmission of the fourth sidelink data may be performed through the second carrier. Conversely, if the packet loss rate is higher than the threshold value, the transmission of the fourth sidelink data is not performed through the second carrier.

For example, the communication quality is determined based on a receiving status of the fourth sidelink data, and if the receiving status of the fourth sidelink data indicates activation once feedback information has not been received for x consecutive times, and x is higher than a threshold value, then the transmission of the fourth sidelink data may be performed through the second carrier. Conversely, if the receiving status of the fourth sidelink data indicates activation once feedback information has not been received for x consecutive times, and x is lower than the threshold value, then the transmission of the fourth sidelink data is not performed through the second carrier, where x is a positive integer.

If whether transmission of the fourth sidelink data is performed through the second carrier is determined based on the resource congestion condition, in some implementations, if the resource congestion condition is severe (e.g., the CBR is above a threshold value), the transmission of the fourth sidelink data may not be performed through the second carrier. In other implementations, if the resource congestion condition is not severe (e.g., the CBR is below the threshold value), the transmission of the fourth sidelink data is performed through the second carrier.

Of course, in the embodiment of the present disclosure, whether transmission of the fourth sidelink data is performed through the second carrier can further be determined by other means. In some implementations, whether transmission of the fourth sidelink data is performed through the second carrier may be determined based on a preset rule.

In other implementations, whether transmission of the fourth sidelink data is performed through the second carrier may be determined based on an upper layer (for example, NAS) indication. For example, whether transmission of the fourth sidelink data is performed through the second carrier may be determined based on third information, where for description of the third information, reference can be made to the above, which will not be repeated for the sake of brevity. For another example, whether transmission of the fourth sidelink data is performed through the second carrier may be determined based on a first association relationship associated with the third information, where for description of the first association relationship, reference can be made to the above, which will not be repeated for the sake of brevity.

In other implementations, whether transmission of the fourth sidelink data is performed through the second carrier may be determined based on an AS configuration. Activation of the AS configuration may be configured, for example, per bearer; or activation of the AS configuration may be configured, for example, per LCH; or activation of the AS configuration may be configured, for example, per link; or activation of the AS configuration may be configured, for example, per sidelink grant; or activation of the AS configuration may be configured, for example, per Configured Grant (CG). The AS configuration may be configured by a network device or another terminal device.

In other implementations, whether transmission of the fourth sidelink data is performed through the second carrier may be determined based on dynamic indication (or indication information). Herein, the indication information may be configured by a network device or another terminal device. Further, the indication information may be carried in one or more of the following: MAC CE, SCI, and DCI.

The determination of whether transmission of the fourth sidelink data is performed through the second carrier may be performed by the first terminal device or the second terminal device. Of course, in the embodiment of the present disclosure, the determination of whether transmission of the fourth sidelink data is performed through the second carrier may also be determined by the network device, and the embodiment of the present disclosure is not limited thereto.

The embodiments of the method of the present disclosure are described in detail with reference to FIG. 1 to FIG. 10, and embodiments of the device of the present disclosure are described in detail with reference to FIG. 11 to FIG. 13. It should be understood that the description of the method embodiments corresponds to the description of respective device embodiments, therefore for portions not described in detail, reference can be made to the foregoing method embodiments.

FIG. 11 is a schematic diagram of a terminal device according to an embodiment of the present disclosure, the terminal device 1100 shown in FIG. 11 is a first terminal device, and the terminal device 1100 includes a communication unit 1110.

The communication unit 1110 is configured to send first information to a second terminal device through a first carrier.

The communication unit 1110 is configured to receive or send second information through a second carrier, where the first carrier is different from the second carrier, and the second information is associated with the first information.

In some implementations, the second carrier is determined based on third information, and the third information includes one or more of: information of a target service type, information of a target service, information of a target application type, information of a target application, Layer 2 information, information of a transmission configuration, information of a target Quality of Service (QoS) flow, and information of a data transmission type.

In some implementations, the second carrier is determined based on a first association relationship between the second carrier and the third information.

In some implementations, the second carrier belongs to a first set of carriers, and the first association relationship includes an association relationship between the first set of carriers and the first information, where the first set of carriers includes one or more carriers available for transmission of the second information.

In some implementations, the time-frequency resource for transmission of the second information belongs to a second resource pool corresponding to the second carrier, where the second resource pool and/or the second carrier is determined based on fourth information, and the fourth information includes one or more of: information of the first carrier, the information of the target QoS flow, information of a logical channel, information of a first resource pool for transmission of the first information, information of a target radio bearer, a target data priority, a congestion degree of the first resource pool, and predefined information.

In some implementations, the second resource pool is determined based on a second association relationship, where the second association relationship includes an association relationship between the second resource pool and the second carrier, and an association relationship between the second carrier and the fourth information.

In some implementations, the second association relationship includes an association relationship between the second resource pool and a second set of carriers, and an association relationship between the second set of carriers and the fourth information, where the second set of carriers includes one or more carriers available for transmission of the second information.

In some implementations, the second carrier is determined based on fifth information, the fifth information including one or more of: Layer 2 information, a frequency domain resource of the first information, configuration information of a first resource pool, and configuration information of a second resource pool, where the first resource pool is used for transmission of the first information, and the second resource pool is used for transmission of the second information.

In some implementations, the second carrier belongs to a third set of carriers, and the third set of carriers is determined based on the fifth information, where the third set of carriers includes one or more carriers available for transmission of the second information.

In some implementations, the sending unit is further configured to: send first indication information to the second terminal device, the first indication information being used to indicate the second carrier.

In some implementations, the first indication information includes one or more of: indication information of the second carrier; indication information of a second resource pool for transmission of the second information; indication information of a time domain resource for transmission of the second information; and indication information of a frequency domain resource for transmission of the second information.

In some implementations, the first carrier and/or the second carrier is determined based on negotiation between the first terminal device and the second terminal device.

In some implementations, the sending unit is configured to send capability information of the first terminal device to the second terminal device, where the capability information of the first terminal device is used to indicate a carrier supported by the first terminal device and/or a number of carriers supported by the first terminal device; and/or, the receiving unit is configured to receive capability information of the second terminal device sent by the second terminal device, where the capability information of the second terminal device is used to indicate a carrier supported by the second terminal device and/or a number of carriers supported by the second terminal device.

In some implementations, the sending unit is configured to send first configuration information to the second terminal device, where the first configuration information is used to configure the first carrier and/or the second carrier for the second terminal device; and/or, the receiving unit is configured to receive second configuration information sent by the second terminal device, where the second configuration information is used to configure the first carrier and/or the second carrier for the first terminal device.

In some implementations, the first configuration information and/or the second configuration information is used to configure a fourth set of carriers, where the fourth set of carriers includes one or more carriers available for transmission of the first information and/or the second information.

In some implementations, a carrier used for transmission of the first information and/or the second information in the fourth set of carriers is determined based on second indication information, the second indication information being indicated by the first terminal device and/or the second terminal device.

In some implementations, the sending unit is configured to receive the third indication information, or the receiving unit is configured to receive or send the third indication information, where the third indication information is used to indicate whether transmission of the second information is allowed to be performed through the second carrier.

In some implementations, whether transmission of the second information is performed through the second carrier is determined based on one or more of: whether a carrier available for transmission of the second information exists; a QoS parameter associated with the first information; a quality of communication between the first terminal device and the second terminal device; and a resource congestion condition of resources available for transmission of the second information.

In some implementations, the first information includes sidelink data, and the second information includes feedback information for the sidelink data; and/or the first information is carried on a first Physical Sidelink Shared Channel (PSSCH), and the second information is carried on a first Physical Sidelink Feedback Channel (PSFCH) associated with the first PSSCH.

In some implementations, the second carrier is one of a plurality of carriers, the second information is one of a plurality of pieces of second information, and transmission of the plurality of pieces of second information is performed through the plurality of carriers respectively.

In some implementations, a Radio Link Failure (RLF) of a radio link for transmission of the first information is determined based on information that is not successfully received in a target carrier, the target carrier being one of the plurality of carriers, or the target carrier including the plurality of carriers.

In some implementations, transmission of the first information and/or the second information is associated with a first timer for Sidelink Discontinuous Reception (SL DRX), and starting of the first timer is determined based on one or more of: a PSFCH resource on the first carrier; a PSFCH resource with a latest time domain position among a plurality of carriers, where the plurality of carriers are carriers for transmission of the second information, and the plurality of carriers include the second carrier; a PSFCH resource on a carrier having a highest priority among the plurality of carriers; and a PSFCH resource on a primary carrier of the plurality of carriers.

In some implementations, the first timer is used to determine a round-trip time for transmission of the first information, or the first timer is used to determine a retransmission time for the first information.

In some implementations, the second information includes first sidelink data, and the first information includes first sidelink control information for scheduling the first sidelink data; and/or, the second information is carried on a second PSSCH, and the first information is carried on a first Physical Sidelink Control Channel (PSCCH) for scheduling the second PSSCH.

In some implementations, the first information further includes second sidelink data scheduled by the first sidelink control information; or the second information further includes second sidelink control information associated with the first sidelink data.

In some implementations, transmission of the first information is performed through a first resource pool, and transmission of the second information is performed through a second resource pool, where the first resource pool is used for transmission of a PSCCH, and the second resource pool is used for transmission of a PSSCH; or, the first resource pool is used for transmission of sidelink control information, and the second resource pool is used for transmission of sidelink data.

In some implementations, a sidelink resource for transmission of the second information is determined based on a resource detection result, and the resource detection result includes a resource detection result for the first resource pool and/or a resource detection result for the second resource pool.

In some implementations, transmission of the second information is associated with a second timer for SL DRX, the second timer is associated with the first carrier, and/or the second timer is associated with the second carrier.

In some implementations, the second timer is used to determine inactivation time of the second terminal device, or the second timer is used to determine round-trip time for transmission of the first information.

In some implementations, if the first terminal device sends the second information, the first information includes first sidelink data, and the second information includes second sidelink data, where the second sidelink data is retransmission data of the first sidelink data.

In some implementations, the first sidelink data is initial transmission data, or the first sidelink data is retransmission data.

FIG. 12 is a schematic diagram of a terminal device according to another embodiment of the present disclosure, the terminal device 1200 shown in FIG. 12 is a second terminal device, and the terminal device 1200 includes a communication unit 1210.

The communication unit 1210 is configured to receive, through a first carrier, first information sent by a first terminal device.

The communication unit 1210 is configured to receive or send second information through a second carrier, where the first carrier is different from the second carrier, and the second information is associated with the first information.

In some implementations, the second carrier is determined based on third information, and the third information includes one or more of: information of a target service type, information of a target service, information of a target application type, information of a target application, Layer 2 information, information of a transmission configuration, information of a target Quality of Service (QoS) flow, and information of a data transmission type.

In some implementations, the second carrier is determined based on a first association relationship between the second carrier and the third information.

In some implementations, the second carrier belongs to a first set of carriers, and the first association relationship includes an association relationship between the first set of carriers and the third information, where the first set of carriers includes one or more carriers available for transmission of the second information.

In some implementations, the time-frequency resource for transmission of the second information belongs to a second resource pool corresponding to the second carrier, where the second resource pool and/or the second carrier is determined based on fourth information, and the fourth information includes one or more of: information of the first carrier, the information of the target QoS flow, information of a logical channel, information of a first resource pool for transmission of the first information, information of a target radio bearer, a target data priority, a congestion degree of the first resource pool, and predefined information.

In some implementations, the second resource pool is determined based on a second association relationship, where the second association relationship includes an association relationship between the second resource pool and the second carrier, and an association relationship between the second carrier and the fourth information.

In some implementations, the second association relationship includes an association relationship between the second resource pool and a second set of carriers, and an association relationship between the second set of carriers and the fourth information, where the second set of carriers includes one or more carriers available for transmission of the second information.

In some implementations, the second carrier is determined based on fifth information, the fifth information including one or more of: Layer 2 information, a frequency domain resource of the first information, configuration information of a first resource pool, and configuration information of a second resource pool, where the first resource pool is used for transmission of the first information, and the second resource pool is used for transmission of the second information.

In some implementations, the second carrier belongs to a third set of carriers, and the third set of carriers is determined based on the fifth information, where the third set of carriers includes one or more carriers available for transmission of the second information.

In some implementations, the receiving unit is further configured to: receive first indication information sent by the first terminal device, the first indication information being used to indicate the second carrier.

In some implementations, the first indication information includes one or more of: indication information of the second carrier; indication information of a second resource pool for transmission of the second information; indication information of a time domain resource for transmission of the second information; and indication information of a frequency domain resource for transmission of the second information.

In some implementations, the first carrier and/or the second carrier is determined based on negotiation between the first terminal device and the second terminal device.

In some implementations, the receiving unit is configured to receive capability information of the first terminal device sent by the first terminal device, where the capability information of the first terminal device is used to indicate a carrier supported by the first terminal device and/or a number of carriers supported by the first terminal device; and/or, the sending unit is further configured to send capability information of the second terminal device to the first terminal device, where the capability information of the second terminal device is used to indicate a carrier supported by the second terminal device and/or a number of carriers supported by the second terminal device.

In some implementations, the receiving unit is configured to receive first configuration information sent by the first terminal device, where the first configuration information is used to configure the first carrier and/or the second carrier for the second terminal device; and/or, the sending unit is configured to send second configuration information to the first terminal device, where the second configuration information is used to configure the first carrier and/or the second carrier for the first terminal device.

In some implementations, the first configuration information and/or the second configuration information is used to configure a fourth set of carriers, where the fourth set of carriers includes one or more carriers available for transmission of the first information and/or the second information.

In some implementations, a carrier used for transmission of the first information and/or the second information in the fourth set of carriers is determined based on second indication information, the second indication information being indicated by the first terminal device and/or the second terminal device.

In some implementations, the sending unit is configured to send third indication information, or the receiving unit is configured to receive the third indication information, where the third indication information is used to indicate whether transmission of the second information is allowed to be performed through the second carrier.

In some implementations, whether transmission of the second information is performed through the second carrier is determined based on one or more of: whether a carrier available for transmission of the second information exists; a QoS parameter associated with the first information; a quality of communication between the first terminal device and the second terminal device; and a resource congestion condition of resources available for transmission of the second information.

In some implementations, the first information includes sidelink data, and the second information includes feedback information for the sidelink data; and/or the first information is carried on a first Physical Sidelink Shared Channel (PSSCH), and the second information is carried on a first Physical Sidelink Feedback Channel (PSFCH) associated with the first PSSCH.

In some implementations, the second carrier is one of a plurality of carriers, the second information is one of a plurality of pieces of second information, and transmission of the plurality of pieces of second information is performed through the plurality of carriers respectively.

In some implementations, a Radio Link Failure (RLF) of a radio link for transmission of the first information is determined based on information that is not successfully received in a target carrier, the target carrier being one of the plurality of carriers, or the target carrier including the plurality of carriers.

In some implementations, transmission of the first information and/or the second information is associated with a first timer for Sidelink Discontinuous Reception (SL DRX), and starting of the first timer is determined based on one or more of: a PSFCH resource on the first carrier; a PSFCH resource with a latest time domain position among a plurality of carriers, where the plurality of carriers are carriers for transmission of the second information, and the plurality of carriers include the second carrier; a PSFCH resource on a carrier having a highest priority among the plurality of carriers; and a PSFCH resource on a primary carrier of the plurality of carriers.

In some implementations, the first timer is used to determine a round-trip time for transmission of the first information, or the first timer is used to determine a retransmission time for the first information.

In some implementations, the second information includes first sidelink data, and the first information includes first sidelink control information for scheduling the first sidelink data; and/or, the second information is carried on a second PSSCH, and the first information is carried on a first Physical Sidelink Control Channel (PSCCH) for scheduling the second PSSCH.

In some implementations, the first information further includes second sidelink data scheduled by the first sidelink control information; or the second information further includes second sidelink control information associated with the first sidelink data.

In some implementations, transmission of the first information is performed through a first resource pool, and transmission of the second information is performed through a second resource pool, where the first resource pool is used for transmission of a PSCCH, and the second resource pool is used for transmission of a PSSCH; or, the first resource pool is used for transmission of sidelink control information, and the second resource pool is used for transmission of sidelink data.

In some implementations, a sidelink resource for transmission of the second information is determined based on a resource detection result, and the resource detection result includes a resource detection result for the first resource pool and/or a resource detection result for the second resource pool.

In some implementations, transmission of the second information is associated with a second timer for SL DRX, the second timer is associated with the first carrier, and/or the second timer is associated with the second carrier.

In some implementations, the second timer is used to determine inactivation time of the second terminal device, or the second timer is used to determine round-trip time for transmission of the first information.

In some implementations, if the first terminal device sends the second information, the first information includes first sidelink data, and the second information includes second sidelink data, where the second sidelink data is retransmission data of the first sidelink data.

In some implementations, the first sidelink data is initial transmission data, or the first sidelink data is retransmission data.

In an optional embodiment, the communication unit 1110 may be a transceiver 1330. The terminal device 1100 may further include a processor 1310 and a memory 1320, as specifically shown in FIG. 13.

In an optional embodiment, the communication unit 1210 may be a transceiver 1330. The terminal device 1200 may further include a processor 1310 and a memory 1320, as specifically shown in FIG. 13.

FIG. 13 is a schematic structural diagram of a communication device according to an embodiment of the present disclosure. The dashed line in FIG. 13 indicates that the unit or module is optional. The apparatus 1300 may be used to implement the method in the method embodiments described above. The apparatus 1300 may be a chip, a terminal device, or a network device.

The apparatus 1300 may include one or more processors 1310. The processor 1310 may support the apparatus 1300 to implement the methods described in the previous method embodiments. The processor 1310 may be a general-purpose processor or a special-purpose processor. For example, the processor may be a Central Processing Unit (CPU). Alternatively, the processor may also be another general purpose processor, a Digital Signal Processor (DSP), an Application Specific Integrated Circuit (ASIC), a Field Programmable Gate Array (FPGA) or other programmable logic device, a discrete gate or transistor logic device, a discrete hardware component, or the like. The general-purpose processor may be a microprocessor or the processor may be any conventional processor or the like.

The apparatus 1300 may also include one or more memories 1320. The memory 1320 has stored a program that can be executed by the processor 1310 to cause the processor 1310 to perform the method described in the above method embodiments. The memory 1320 may be independent of the processor 1310 or may be integrated in the processor 1310.

The apparatus 1300 may also include a transceiver 1330. The processor 1310 may communicate with other devices or chips through the transceiver 1330. For example, the processor 1310 may transmit and receive data to or from other devices or chips through the transceiver 1330.

The embodiments of the present disclosure also provide a computer-readable storage medium for storing a program. The computer-readable storage medium can be applied to a terminal or a network device provided by an embodiment of the present disclosure, and the program causes a computer to implement a method performed by the terminal or the network device in each embodiment of the present disclosure.

The embodiments of the present disclosure also provide a computer program product. The computer program product includes a program. The computer program product can be applied to a terminal or a network device provided by an embodiment of the present disclosure, and the program causes a computer to implement a method performed by the terminal or the network device in each embodiment of the present disclosure.

The embodiments of the present disclosure also provide a computer program. The computer program can be applied to a terminal or a network device provided by an embodiment of the present disclosure, and the computer program causes a computer to implement a method performed by the terminal or the network device in each embodiment of the present disclosure.

It is to be understood that the terms “system” and “network” may be used interchangeably in the present disclosure. In addition, the terminology used in the present disclosure is for explanation of specific embodiments of the present disclosure only, and is not intended to limit the present disclosure. The terms “first”, “second”, “third” and “fourth” etc. in the description and claims of the present disclosure and the accompanying drawings are used to distinguish different objects, and are not used to describe a specific order. Furthermore, the terms “including” and “having” and any variations thereof are intended to convey non-exclusive inclusions.

In the embodiments of the present disclosure, the “indication” mentioned may be a direct indication, an indirect indication, or may represent that there is an association relationship. For example, A indicates B, which may represent that A directly indicates B, for example, B can be acquired by A; it may also represent that A indicates B indirectly, for example A indicates C, and B can be acquired through C; and it may also represent that there is an association relationship between A and B.

In the embodiments of the present disclosure, “B corresponding to A” means that B is associated with A, and B can be determined from A. However, it should also be understood that determining B from A does not mean that B is determined from A alone, and that B may also be determined from A and/or other information.

In the embodiments of the present disclosure, it should also be understood that the term “corresponding to” in the embodiments of the present disclosure may represent that there is a direct correspondence or an indirect correspondence between two objects, or may further represent that there is an association relationship between the two objects, or may represent a relationship of indicating and being indicated, or configuring and being configured, etc.

In the embodiments of the present disclosure, “predefined” or “pre-configured” may be realized by storing corresponding codes, tables, or other methods that can be used to indicate relevant information in advance in devices (including, for example, terminal devices and network devices), and the present disclosure does not limit specific implementation methods thereof. For example, the term “predefined” may mean that it is defined in a protocol.

In the embodiments of the present disclosure, the “protocol” may refer to a standard protocol in the communication field, and may include, for example, an LTE protocol, an NR protocol, and related protocols applied to future communication systems, which is not limited in the present disclosure.

The term “and/or” in the embodiments of the present disclosure is only an association relationship between objects, and indicates that there may be three kinds of relationships. For example, A and/or B may indicate that A exists alone, A and B exist simultaneously, and B exists alone. In addition, the character “/” in this article generally indicates that the related objects before and after this character are in an “or” relationship.

In various embodiments of the present disclosure, the sequence numbers of the above-described processes do not mean a sequence of execution, and the sequence of execution of each process should be determined by its function and internal logic, and the sequence numbers should not constitute any limitation on the implementation process of the embodiments of the present disclosure.

It should be understood that the systems, apparatuses and methods disclosed in various embodiments of the present disclosure may be implemented in other ways. For example, the device embodiments described above are merely schematic. For example, the division of units is only a division in terms of logical functions, and there may be other division methods in actual implementations. For example, multiple units or components may be combined or integrated into another system, or some features may be ignored or not implemented. In addition, the coupling or direct coupling or communication connection between each other shown or discussed herein may be an indirect coupling, or a communication connection through some interfaces, devices or units, and the coupling or communication connection may be electrical, mechanical or in other forms.

The units described as separate units may or may not be physically separate, and the units displayed as units may or may not be physical units. That is to say, they may be located in one place or may be distributed over multiple network units. Some or all of the units may be selected according to actual needs to achieve the purpose of the schemes of the embodiments.

In addition, functional units in various embodiments of the present disclosure may be integrated in one processing unit, may be physically present separately, or two or more units may be integrated in one unit.

The embodiments described above may be implemented in whole or in part by software, hardware, firmware, or any combination thereof. When implemented using software, they may be implemented in whole or in part in the form of a computer program product. The computer program product includes one or more computer instructions. When the computer program instructions are loaded and executed on a computer, the processes or functions described in accordance with embodiments of the present disclosure are implemented in whole or in part. The computer may be a general-purpose computer, a special-purpose computer, a computer network, or any other programmable device. The computer instructions may be stored in a computer-readable storage medium or transmitted from one computer-readable storage medium to another computer-readable storage medium. For example, the computer instructions may be transmitted from one website site, computer, server, or data center by wired (e.g., coaxial cable, optical fiber, digital subscriber line (DSL)) or wireless (e.g., infrared, wireless, microwave, etc.) means to another website site, computer, server, or data center. The computer-readable storage medium may be any available medium that can be read by a computer, or a data storage device such as a server, a data center, or the like that is integrated from one or more available media. The available media may be magnetic media (e.g., floppy disk, hard disk, magnetic tape), optical media (e.g., Digital Video Disc (DVD)), or semiconductor media (e.g., Solid State Disk (SSD)), etc.

The foregoing describes merely specific implementations of the present disclosure, but the scope of protection of the present disclosure is not limited thereto. Any person skilled in the art can readily conceive of changes or substitutions within the technical scope disclosed in the present disclosure, all of which fall within the scope of protection of the present disclosure. Therefore, the scope of protection of the present disclosure should be based on the scope of protection of the claims.

1. A method for sidelink communication, comprising:
sending, by a first terminal device, first information to a second terminal device through a first carrier; and
receiving or sending, by the first terminal device, second information through a second carrier, wherein the first carrier is different from the second carrier, and the second information is associated with the first information.

2. The method of claim 1, wherein the second carrier is determined based on third information, and the third information comprises one or more of: Layer 2 information, information of a transmission configuration, information of a target Quality of Service (QoS) flow, and information of a data transmission type.

3. The method of claim 2, wherein the second carrier is determined based on a first association relationship between the second carrier and the third information.

4. The method of claim 3, wherein the second carrier belongs to a first set of carriers, and the first association relationship comprises an association relationship between the first set of carriers and the third information, wherein the first set of carriers comprises one or more carriers available for transmission of the second information.

5. The method of claim 1, wherein at least one of the first carrier or the second carrier is determined based on negotiation between the first terminal device and the second terminal device.

6. The method of claim 1, further comprising at least one of:
sending, by the first terminal device, capability information of the first terminal device to the second terminal device, wherein the capability information of the first terminal device is used to indicate a carrier supported by the first terminal device and/or a number of carriers supported by the first terminal device; or
receiving, by the first terminal device, capability information of the second terminal device sent by the second terminal device, wherein the capability information of the second terminal device is used to indicate a carrier supported by the second terminal device and/or a number of carriers supported by the second terminal device.

7. The method of claim 1, further comprising:
sending, by the first terminal device, first configuration information to the second terminal device, wherein the first configuration information is used to configure the first carrier and/or the second carrier for the second terminal device; and/or receiving, by the first terminal device, second configuration information sent by the second terminal device, wherein the second configuration information is used to configure the first carrier and/or the second carrier for the first terminal device.

8. A first terminal device, comprising: a transceiver, a memory configured to store computer-executable instructions, and a processor configured to invoke and execute the computer-executable instructions in the memory to perform operations of:
sending, via the transceiver, first information to a second terminal device through a first carrier; and
receiving or sending, via the transceiver, second information through a second carrier, wherein the first carrier is different from the second carrier, and the second information is associated with the first information.

9. The first terminal device of claim 8, wherein the second carrier is determined based on third information, and the third information comprises one or more of: Layer 2 information, information of a transmission configuration, information of a target Quality of Service (QoS) flow, and information of a data transmission type.

10. The first terminal device of claim 9, wherein the second carrier is determined based on a first association relationship between the second carrier and the third information.

11. The first terminal device of claim 10, wherein the second carrier belongs to a first set of carriers, and the first association relationship comprises an association relationship between the first set of carriers and the third information, wherein the first set of carriers comprises one or more carriers available for transmission of the second information.

12. The first terminal device of claim 8, wherein at least one of the first carrier or the second carrier is determined based on negotiation between the first terminal device and the second terminal device.

13. The first terminal device of claim 8, wherein the processor is configured to invoke and execute the computer-executable instructions in the memory to further perform at least one of operations of:
sending, via the transceiver, capability information of the first terminal device to the second terminal device, wherein the capability information of the first terminal device is used to indicate a carrier supported by the first terminal device and/or a number of carriers supported by the first terminal device; or
receiving, via the transceiver, capability information of the second terminal device sent by the second terminal device, wherein the capability information of the second terminal device is used to indicate a carrier supported by the second terminal device and/or a number of carriers supported by the second terminal device.

14. The first terminal device of claim 8, wherein whether transmission of the second information is performed through the second carrier is determined based on one or more of:
whether a carrier available for transmission of the second information exists; and
a QoS parameter associated with the first information.

15. A second terminal device, comprising: a transceiver, a memory configured to store computer-executable instructions, and a processor configured to invoke and execute the computer-executable instructions in the memory to perform operations of:
receiving, via the transceiver through a first carrier, first information sent by a first terminal device; and
receiving or sending, via the transceiver, second information through a second carrier, wherein the first carrier is different from the second carrier, and the second information is associated with the first information.

16. The second terminal device of claim 15, wherein the second carrier is determined based on third information, and the third information comprises one or more of: Layer 2 information, information of a transmission configuration, information of a target Quality of Service (QoS) flow, and information of a data transmission type.

17. The second terminal device of claim 16, wherein the second carrier is determined based on a first association relationship between the second carrier and the third information.

18. The second terminal device of claim 17, wherein the second carrier belongs to a first set of carriers, and the first association relationship comprises an association relationship between the first set of carriers and the third information, wherein the first set of carriers comprises one or more carriers available for transmission of the second information.

19. The second terminal device of claim 15, wherein at least one of the first carrier or the second carrier is determined based on negotiation between the first terminal device and the second terminal device.

20. The second terminal device of claim 15, wherein the processor is configured to invoke and execute the computer-executable instructions in the memory to further perform at least one of operations of:
receiving, via the transceiver, capability information of the first terminal device sent by the first terminal device, wherein the capability information of the first terminal device is used to indicate a carrier supported by the first terminal device and/or a number of carriers supported by the first terminal device; or
sending, via the transceiver, capability information of the second terminal device to the first terminal device, wherein the capability information of the second terminal device is used to indicate a carrier supported by the second terminal device and/or a number of carriers supported by the second terminal device.
